(19) United States
(12) Patent Application Publication
(10) Pub. No.: US 2026/0189759 A1
(43) Pub. Date: Jul. 2, 2026

(54) APPLIED SUBSCRIBER REACTIVATION PROPENSITY MODEL

(71) Applicant: Sling TV L.L.C., Englewood, CO (US)

(72) Inventors: Aakash Kotha, Denver, CO (US); Vineet Parsai, Denver, CO (US); Rajesh Makala, Liberty Hill, TX (US)

(21) Appl. No.: 19/005,572

(22) Filed: Dec. 30, 2024

(51) Int. Cl. H04N 21/466

(52) U.S. Cl. CPC H04N 21/4667; H04N 21/4665; H04N 21/4668

(57) ABSTRACT

A disclosed method may include (i) generating, using a machine learning algorithm, prediction models where each of the prediction models corresponds to a respective subset of an overall time period such that each of the prediction models predicts, for each former subscriber in an input set of former subscribers, a probability of the former subscriber restarting a subscription during the subset of the overall time period and (ii) applying, based on a determination that an actual subset of the overall time period is arriving, a specific prediction model for that actual subset of the overall time period such that a target set of former subscribers is identified that identifies former subscribers with a probability of restarting their subscription beyond a predetermined threshold during the actual subset of the overall time period

### BRIEF SUMMARY

This disclosure is generally directed to systems, methods, and computer-readable media relating to an applied subscriber reactivation propensity model. Technology subscription services, including satellite TV and cell service providers, have become prevalent in modern society, offering users access to a wide array of content and communication options. However, these services may face challenges in retaining subscribers and reactivating former customers. One issue that technology subscription platforms may encounter is the difficulty in predicting when a former subscriber is likely to restart their subscription. This unpredictability may lead to inefficient marketing strategies, where resources are potentially wasted on users who are unlikely to return or on those who would have returned without any incentive. In some scenarios, service providers may send out generic reactivation messages to all former subscribers, regardless of their individual likelihood of returning. This one-size-fits-all technique may result in missed opportunities to engage with high-potential subscribers while unnecessarily spending resources on those with low reactivation probabilities.

A technique that may address this challenge involves developing a sophisticated prediction model that not only estimates the likelihood of a subscriber restarting but also forecasts the specific time period in which this reactivation is most probable. Such a model may incorporate various data points, such as historical usage patterns, subscription history, and demographic information, to create a more nuanced understanding of each former subscriber's behavior. By analyzing these factors, the model may generate personalized probability scores for each user, indicating both their likelihood of restarting and the optimal time frame for reactivation. This technique may allow technology subscription services to tailor their marketing efforts more precisely, potentially reducing unnecessary expenditures and increasing the effectiveness of their reactivation campaigns. For example, the system may identify subscribers with a high probability of restarting in the near future and prioritize them for targeted marketing efforts, while adopting a different strategy for those with lower probabilities or longer expected time frames for reactivation. In the case of a satellite TV provider, the model might predict that a former subscriber who regularly watched sports content is more likely to reactivate just before a major sporting event, allowing the provider to time their outreach accordingly.

Another problem that technology subscription services may face is the lack of personalization in their reactivation strategies. Generic marketing messages and offers may not resonate with all former subscribers, potentially leading to lower engagement and conversion rates. In some cases, service providers may send out blanket emails or notifications to all former subscribers, promoting the same content or offers regardless of individual preferences or past usage habits. This generalized technique may result in messages that feel irrelevant or uninteresting to many recipients, potentially causing them to ignore or dismiss the reactivation attempts. A technique that may improve this situation involves leveraging historical usage data and subscription patterns to create highly personalized recommendations and offers. By analyzing a former subscriber's past behavior, including their preferred features, usage habits, and the reasons for their initial cancellation, technology subscription services may be able to craft tailored messages that speak directly to each individual's interests and needs. This personalized technique may increase the likelihood of reactivation by presenting former subscribers with content and offers that are more relevant and appealing to them. For instance, a cell service provider who primarily used data-heavy applications before cancelling may receive a reactivation message highlighting new unlimited data plans or improved network coverage in their area. Similarly, a satellite TV subscriber who frequently recorded shows may be enticed with information about enhanced DVR capabilities or new on-demand content that aligns with their viewing history. By incorporating this level of personalization, technology subscription services may create a more engaging and effective reactivation experience for each former subscriber, potentially increasing the chances of successful reactivation and long-term retention. This personalized technique may be particularly effective in highly competitive markets where consumers have multiple options, as it allows providers to differentiate themselves by demonstrating a deep understanding of each individual's needs and preferences.

The dynamic nature of the technology subscription industry, with constantly changing service offerings and consumer preferences, may present another challenge for reactivation efforts. What worked to bring back subscribers in the past may not be as effective in the present or future. Service providers may find that their reactivation strategies become outdated quickly as new features are added, usage trends shift, or competitive landscapes evolve. This rapid change may make it difficult for marketing teams to keep up and maintain the relevance and effectiveness of their reactivation campaigns. A technique that may address this issue involves implementing an automated, self-improving prediction system that continuously updates its models based on new data and changing market conditions. This system may use machine learning algorithms to analyze patterns in subscriber behavior, service usage, and external factors such as technological advancements or economic trends. The system may ingest vast amounts of data on a regular basis, including new subscriber sign-ups, cancellations, usage statistics, and feature additions or removals. By processing this information, the system may identify emerging trends, such as sudden increases in demand for certain types of services or changes in usage patterns around specific events or seasons. These insights may then be used to refine the prediction models and adjust reactivation strategies accordingly. For example, if the system detects a surge in interest for 5G services, it may automatically update the reactivation messages for relevant former cell service subscribers to highlight the provider's 5G capabilities. By regularly refining its predictions, the system may adapt to shifts in the technology landscape, potentially maintaining its effectiveness over time and providing subscription services with up-to-date insights for their reactivation strategies. This adaptive technique may help technology subscription platforms stay ahead of changing consumer preferences and market dynamics, potentially improving the success rate of their reactivation efforts and maintaining a competitive edge in the industry. The self-improving nature of this system may be particularly valuable in the fast-paced technology sector, where new innovations and competitors may rapidly change the market landscape.

One more challenge that technology subscription services may encounter is the difficulty in determining the optimal level of investment for each reactivation attempt. Offering too generous incentives to subscribers who would have returned anyway may result in unnecessary revenue loss, while providing insufficient motivation to those who need more convincing may lead to missed opportunities. This balancing act may be particularly challenging when dealing with a large and diverse former subscriber base, where individual motivations and price sensitivities may vary widely. In some cases, service providers may resort to a one-size-fits-all technique for offers and incentives, which may be suboptimal for maximizing reactivation rates while minimizing costs. A technique that may help balance these considerations involves segmenting former subscribers into different probability tiers based on their likelihood of restarting. This segmentation may allow for a more nuanced technique to resource allocation, where high-probability restarters receive minimal or no incentives, medium-probability subscribers are offered moderate deals, and low-probability users are targeted with more substantial offers. The segmentation process may take into account various factors, such as the length of time since cancellation, historical engagement levels, and the predicted probability of reactivation. By fine-tuning the level of investment for each segment, technology subscription services may be able to optimize their marketing spend and maximize the return on their reactivation efforts. For example, a former satellite TV subscriber with a high probability of restarting may receive a simple reminder email about new channel additions, while a low-probability subscriber might be offered a significant discount or an extended free trial period. This targeted technique may help service providers allocate their resources more efficiently, potentially reducing unnecessary spending on subscribers likely to return organically while still providing attractive incentives to those who need an extra push. Additionally, this segmented technique may allow for more accurate measurement of the effectiveness of different incentive levels, enabling continuous refinement of the reactivation strategy over time. In the context of cell service providers, this might involve offering minimal incentives to customers who frequently switch between providers, while reserving more substantial offers for long-term former customers who may require a stronger motivation to return.

The abundance of data available to technology subscription services may paradoxically become a hindrance if not properly managed and utilized. The sheer volume of information about subscriber behavior, service performance, and market trends may overwhelm traditional analysis methods, potentially leading to missed insights or delayed decision-making. Service providers may find themselves inundated with data from various sources, including user interactions, usage histories, device information, and external market data. This data overload may make it challenging for marketing teams to extract meaningful patterns and actionable insights in a timely manner, potentially hampering their ability to create effective reactivation strategies. A technique that may address this data overload involves implementing advanced data processing and visualization tools that can quickly sort through vast amounts of information and present actionable insights in an easily digestible format. These tools may use techniques such as data clustering, anomaly detection, and predictive analytics to identify patterns and trends that might otherwise go unnoticed. For example, the system may automatically segment former subscribers based on their usage habits, engagement levels, and cancellation reasons, presenting this information in interactive dashboards that allow marketers to explore different subgroups and their characteristics. The tools may also generate real-time alerts for significant changes in subscriber behavior or market conditions, enabling rapid response to emerging opportunities or threats. By providing clear, real-time visualizations of key metrics and predictions, these tools may empower marketing teams to make more informed and timely decisions about their reactivation strategies, potentially improving the overall effectiveness of their campaigns. This data-driven technique may help technology subscription services transform their abundance of information from a potential liability into a valuable asset, enabling them to craft more targeted and effective reactivation campaigns based on deep, nuanced understandings of their former subscriber base. For instance, a satellite TV provider may use these tools to identify correlations between specific content genres and subscriber retention rates, allowing them to tailor their reactivation offers to highlight the most engaging content for each former subscriber. Similarly, a cell service provider might use the visualization tools to spot trends in data usage patterns, enabling them to create personalized reactivation offers that align with each former subscriber's typical data consumption habits. The ability to quickly process and visualize large amounts of data may also allow these services to respond more rapidly to market changes, such as new competitive offerings or shifts in consumer preferences, potentially giving them an edge in their reactivation efforts.

In the competitive landscape of technology subscription services, timing may be a factor in the success of reactivation efforts. Reaching out to former subscribers at suboptimal moments may result in messages being ignored or poorly received, potentially reducing the chances of reactivation. Service providers may find that sending reactivation messages at arbitrary times or on a fixed schedule fails to capitalize on moments when former subscribers may be most receptive to returning. This suboptimal timing may lead to lower engagement rates and decreased effectiveness of reactivation campaigns. A technique that may improve the timing of reactivation attempts involves developing a predictive model that takes into account not only the likelihood of a subscriber restarting but also the optimal time to make contact. This model may consider factors such as the subscriber's historical usage patterns, the introduction of new features or services that match their interests, and external events that might iNFXuence their decision to resubscribe. For example, the model may identify that a particular former satellite TV subscriber tends to watch more content during specific seasons or around major sporting events, suggesting these as optimal times for reactivation messages. Similarly, for a cell service provider, if a new data plan or device upgrade that aligns with the subscriber's previous usage patterns becomes available, the system may recommend reaching out just as these offerings are introduced. The model may also consider factors such as contract end dates from competing providers, potentially identifying opportune moments when a former subscriber may be more likely to switch back. By identifying the most favorable moments to reach out to each former subscriber, technology subscription services may be able to increase the relevance and impact of their reactivation messages, potentially leading to higher conversion rates and a more efficient use of marketing resources. This timing-optimized technique may help service providers cut through the noise of competing messages and present their offerings at moments when former subscribers are most likely to be receptive, potentially improving the overall success rate of their reactivation efforts. For instance, a satellite TV provider may time its reactivation messages to coincide with the start of a new TV season or a major sporting event, while a cell service provider might target former customers just as their current contracts with competitors are nearing expiration. This nuanced technique to timing may be particularly valuable in industries where services are often seen as interchangeable, helping providers differentiate themselves through personalized and well-timed communication.

In some examples, a method includes (i) generating, using a machine learning algorithm, prediction models where each of the prediction models corresponds to a respective subset of an overall time period such that each of the prediction models predicts, for each former subscriber in an input set of former subscribers, a probability of the former subscriber restarting a subscription during the subset of the overall time period, (ii) applying, based on a determination that an actual subset of the overall time period is arriving, a specific prediction model for that actual subset of the overall time period such that a target set of former subscribers is identified that identifies former subscribers with a probability of restarting their subscription beyond a predetermined threshold during the actual subset of the overall time period, and (iii) transmitting, via an automated marketing platform during or prior to the actual subset of the overall time period, respective reactivation messages to the target set of former subscribers based on the former subscribers in the target set of former subscribers having the probability of restarting their subscription beyond the predetermined threshold during the actual subset of the overall time period according to the machine learning algorithm.

In some examples, the machine learning algorithm comprises a tree-based decision algorithm.

In some examples, the tree-based decision algorithm comprises a gradient boosting algorithm.

In some examples, the machine learning algorithm comprises a Naive Bayes algorithm.

In some examples, the method includes automatically updating the prediction models on a recurring basis using newly acquired subscriber data.

In some examples, each subset of the overall time period corresponds to a month.

In some examples, the method includes segmenting former subscribers into ventiles based on their predicted probabilities of restarting their subscription.

In some examples, the method includes generating the prediction models comprises using historical data of former subscribers, the historical data comprising viewership patterns, subscription packages, or activation history.

In some examples, the reactivation messages comprise personalized content based on their predicted probability.

In some examples, the method includes suppressing marketing efforts for a subset of former subscribers based on their predicted probability of restarting their subscription failing to satisfy the predetermined threshold.

In some examples, the method further includes determining an offer for each former subscriber in the target set of former subscribers based on their predicted probability of restarting their subscription.

In some examples, wherein the automated marketing platform comprises an email system, a messaging system, or an in-app notification system.

In some examples, the method further includes predicting content preferences for each former subscriber in the target set of former subscribers based on their historical viewership data and including content recommendations in the reactivation messages based on the predicted content preferences.

In some examples, the method includes adjusting the predetermined threshold based on market conditions.

In some examples, the method further includes storing the prediction models in a data structure that maps each subset of the overall time period to its corresponding prediction model and selecting, based on the actual subset of the overall time period, the corresponding prediction model from the data structure for applying.

In some examples, the method further includes tracking, over a predetermined evaluation period, actual reactivations of the former subscribers, comparing the actual reactivations to the probabilities predicted by the prediction models, and retraining the prediction models based on results of the comparing to improve prediction accuracy.

In some examples, a non-transitory computer-readable medium has instructions stored thereon that, when executed by at least one physical computing processor, cause a computing device to perform operations comprising (i) generating, using a machine learning algorithm, prediction models where each of the prediction models corresponds to a respective subset of an overall time period such that each of the prediction models predicts, for each former subscriber in an input set of former subscribers, a probability of the former subscriber restarting a subscription during the subset of the overall time period, (ii) applying, based on a determination that an actual subset of the overall time period is arriving, a specific prediction model for that actual subset of the overall time period such that a target set of former subscribers is identified that identifies former subscribers with a probability of restarting their subscription beyond a predetermined threshold during the actual subset of the overall time period, and (iii) transmitting, via an automated marketing platform during or prior to the actual subset of the overall time period, respective reactivation messages to the target set of former subscribers based on the former subscribers in the target set of former subscribers having the probability of restarting their subscription beyond the predetermined threshold during the actual subset of the overall time period according to the machine learning algorithm.

In some examples, a system comprises at least one physical computing processor of a computing device and a non-transitory computer-readable medium that has instructions stored thereon that, when executed by the at least one physical computing processor, cause the computing device to perform operations comprising (i) (i) generating, using a machine learning algorithm, prediction models where each of the prediction models corresponds to a respective subset of an overall time period such that each of the prediction models predicts, for each former subscriber in an input set of former subscribers, a probability of the former subscriber restarting a subscription during the subset of the overall time period, (ii) applying, based on a determination that an actual subset of the overall time period is arriving, a specific prediction model for that actual subset of the overall time period such that a target set of former subscribers is identified that identifies former subscribers with a probability of restarting their subscription beyond a predetermined threshold during the actual subset of the overall time period, and (iii) transmitting, via an automated marketing platform during or prior to the actual subset of the overall time period, respective reactivation messages to the target set of former subscribers based on the former subscribers in the target set of former subscribers having the probability of restarting their subscription beyond the predetermined threshold during the actual subset of the overall time period according to the machine learning algorithm.

### BRIEF DESCRIPTION OF THE DRAWINGS

For a better understanding of the present invention, reference will be made to the following Detailed Description, which is to be read in association with the accompanying drawings:

FIG. 1 is a flow diagram illustrating an example method for predicting and targeting former subscribers for reactivation.

FIG. 2 shows an example user scenario and a schematic representation of a prediction model system.

FIG. 3 illustrates an example process of generating and applying prediction models for different time periods.

FIG. 4 demonstrates an example segmentation of former subscribers and application of targeted marketing strategies.

FIG. 5 depicts an example automated process of updating prediction models and applying them to current data.

FIG. 6 shows an example real-world application of the prediction model system in a streaming service context.

FIG. 7 illustrates an example process of determining and applying marketing strategies based on prediction model outputs.

FIG. 8 demonstrates an example process of content recommendation based on historical viewership data.

FIG. 9 shows an example process of model evaluation and retraining.

FIG. 10 is a block diagram illustrating an example computing device that may be used in at least some implementations of the present disclosure.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

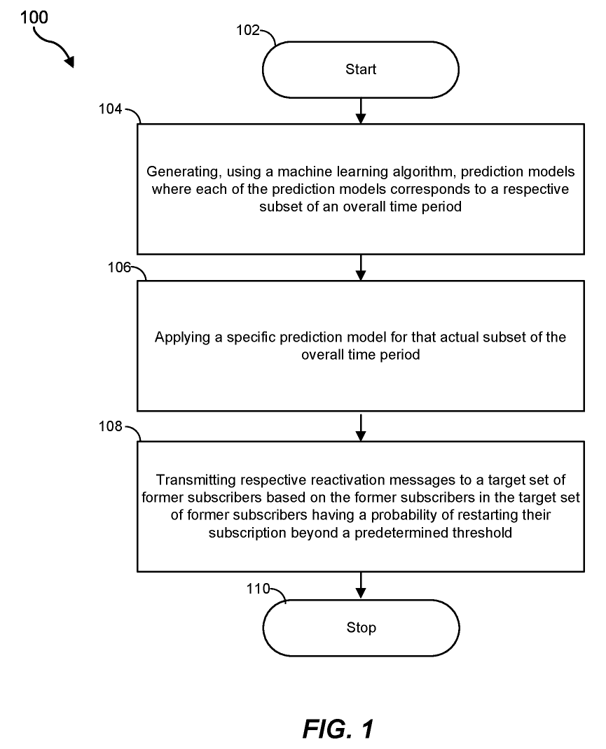

FIG. 1 shows a flow diagram for an example method 100 relating to subscriber reactivation propensity modeling. At step 102, method 100 may start. At step 104, method 100 includes generating, using a machine learning algorithm, prediction models where each of the prediction models corresponds to a respective subset of an overall time period such that each of the prediction models predicts, for each former subscriber in an input set of former subscribers, a probability of the former subscriber restarting a subscription during the subset of the overall time period. At step 106, method 100 includes applying, based on a determination that an actual subset of the overall time period is arriving, a specific prediction model for that actual subset of the overall time period such that a target set of former subscribers is identified that identifies former subscribers with a probability of restarting their subscription beyond a predetermined threshold during the actual subset of the overall time period. At step 108, method 100 includes transmitting, via an automated marketing platform during or prior to the actual subset of the overall time period, respective reactivation messages to the target set of former subscribers based on the former subscribers in the target set of former subscribers having the probability of restarting their subscription beyond the predetermined threshold during the actual subset of the overall time period according to the machine learning algorithm. At step 110, method 100 may end.

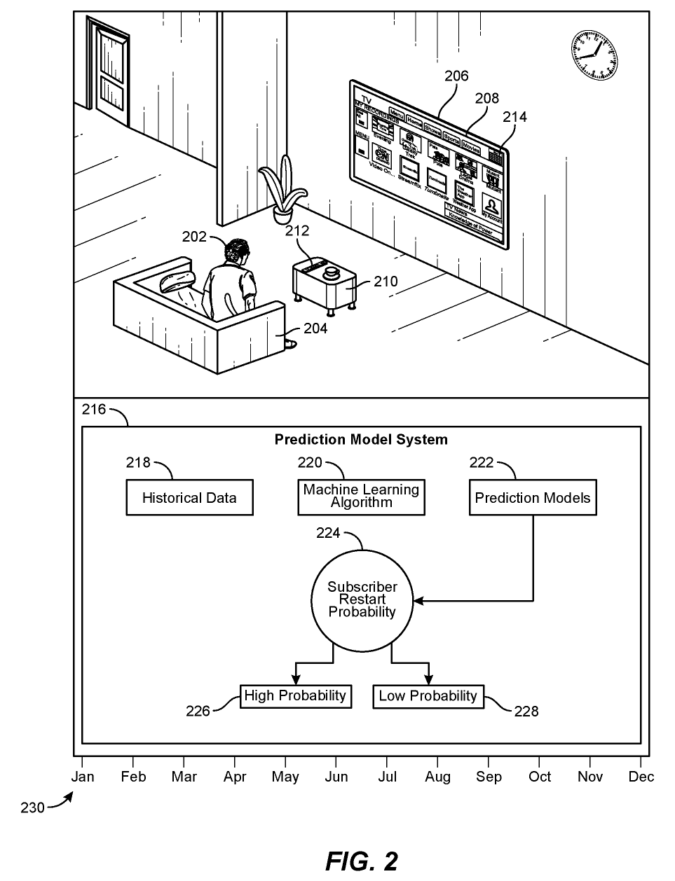

FIG. 2 shows an example user scenario and a schematic representation of a prediction model system. The figure is divided into two panels, top and bottom, each illustrating different aspects of the subscriber reactivation process and the underlying predictive technology that may drive it.

The top panel depicts a real-world setting that may be encountered in the context of subscriber reactivation. This panel presents a living room scene where a person 202 is shown sitting on a couch 204 facing a large TV screen 206. The TV screen 206 prominently displays a streaming service interface 208, which may represent the type of service a former subscriber might consider reactivating. This interface 208 may include a grid of TV show thumbnails, simulating a typical layout found in popular streaming platforms. The selection and arrangement of these thumbnails may not be random; instead, they may be carefully curated based on the viewer's past preferences and viewing habits, as determined by more sophisticated prediction models. In one corner of the TV screen 206, a small calendar icon 214 is visible, showing the current month. This calendar icon 214 may serve as a visual representation of the time-based nature of the prediction models discussed in this disclosure. The presence of this icon 214 may subtly remind viewers of upcoming content or limited-time offers, potentially iNFXuencing their decision to reactivate their subscription. Next to the person 202, a coffee table 210 is depicted with a remote control 212 placed on it, further setting the scene of a typical viewing environment.

In some examples, the streaming service interface 208 displayed on the TV screen 206 may play a significant role in the subscriber reactivation process. The content shown on this interface 208 may be tailored based on the former subscriber's viewing history and preferences, as determined by the prediction models. This personalized content selection may increase the likelihood of reactivation by presenting the most appealing options to each individual former subscriber. For instance, if the prediction model indicates that a particular viewer has a high affinity for science fiction content and tends to reactivate their subscription during the summer months, the interface 208 may prominently feature new or popular science fiction titles scheduled for release in the coming weeks. Additionally, the interface 208 may display personalized messages or offers based on the viewer's predicted probability of reactivation. For high-probability reactivators, the message may be a simple reminder of new content, while for those with lower reactivation probabilities, more substantial incentives or promotional offers may be presented. The calendar icon 214 may be used in conjunction with these personalized elements to create a sense of urgency or timeliness, potentially encouraging viewers to act on reactivation offers before they expire.

The bottom panel of FIG. 2 presents a schematic diagram representing the prediction model system that may drive the reactivation efforts. This panel offers a glimpse into the complex backend processes that may enable the personalized experience depicted in the top panel. At the center of this panel, a large rectangle labeled "Prediction Model System" 216 encompasses certain components of the system. Within this rectangle 216, three smaller rectangles are arranged in a row, labeled "Historical Data" 218, "Machine Learning Algorithm" 220, and "Prediction Models" 222. These components may work in tandem to generate accurate predictions about subscriber reactivation probabilities, forming the backbone of this example intelligent reactivation system. The arrangement of these components within the Prediction Model System 216 may illustrate the flow of information and processing that occurs in generating reactivation predictions.

In some examples, the Historical Data 218 component may include a wide range of information about former subscribers, such as their viewing habits, subscription history, demographic information, and reasons for previous cancellations. This data may serve as the foundation for training the machine learning algorithms and generating the prediction models. The historical data may be continuously updated and refined as new information becomes available, ensuring that the prediction models remain relevant and accurate over time. This component may also include external data sources, such as information about competing services, market trends, or even broader economic indicators that might iNFXuence subscription decisions. The breadth and depth of this historical data may significantly impact the accuracy and reliability of the resulting prediction models.

The Machine Learning Algorithm 220 component may represent the computational techniques used to analyze the historical data and identify patterns that correlate with subscription reactivation. This may include various algorithms such as decision trees, gradient boosting, or neural networks, depending on which technique proves most effective for the specific dataset and prediction task at hand. The choice of algorithm may be dynamically adjusted based on performance metrics, ensuring that the system continually evolves to provide the most accurate predictions possible. In some scenarios, multiple algorithms may be employed simultaneously, with their outputs combined using ensemble methods to produce more robust predictions. The flexibility in algorithm selection and combination may allow the system to adapt to changing patterns in subscriber behavior and market conditions.

The Prediction Models 222 component may represent the output of the machine learning process. These models may be capable of estimating the probability of a former subscriber reactivating their subscription, and/or predicting the optimal time period for reactivation attempts. The models may be periodically retrained and updated to reflect changing subscriber behaviors and market conditions. In some implementations, separate models may be developed for different subscriber segments or time periods, allowing for more nuanced and targeted predictions. The granularity and specificity of these models may be adjusted based on the preferences of the service provider and the characteristics of their subscriber base.

From the "Prediction Models" rectangle 222, an arrow points to a circle labeled "Subscriber Restart Probability" 224. This visualization may illustrate how the system generates a specific probability score for each former subscriber. The process of generating these probabilities may involve complex calculations that take into account numerous factors, potentially including the subscriber's historical engagement level, the duration since their last active subscription, their response to previous reactivation attempts, and/or any relevant external factors. From this circle 224, two arrows extend to rectangles labeled "High Probability" 226 and "Low Probability" 228, representing how subscribers may be categorized based on their likelihood of restarting their subscription. This categorization may inform different marketing strategies, with high-probability subscribers receiving different messages or offers compared to those in the low-probability category. The system may use these probability scores to prioritize reactivation efforts and allocate marketing resources more efficiently.

At the bottom of the bottom panel, a timeline 230 is shown representing the overall time period, with several marks indicating subsets (e.g., months). This timeline 230 may visualize how the prediction models are applied to specific time periods, allowing for targeted marketing efforts based on when a subscriber is most likely to reactivate. The granularity of these time periods may be adjusted based on the specific needs of the service provider and the characteristics of their subscriber base. For instance, some businesses may find monthly predictions sufficient, while others might benefit from weekly or even daily predictions during particularly active periods. The timeline 230 may also be used to visualize seasonal trends or patterns in reactivation behavior, helping service providers to anticipate and prepare for periods of increased reactivation potential.

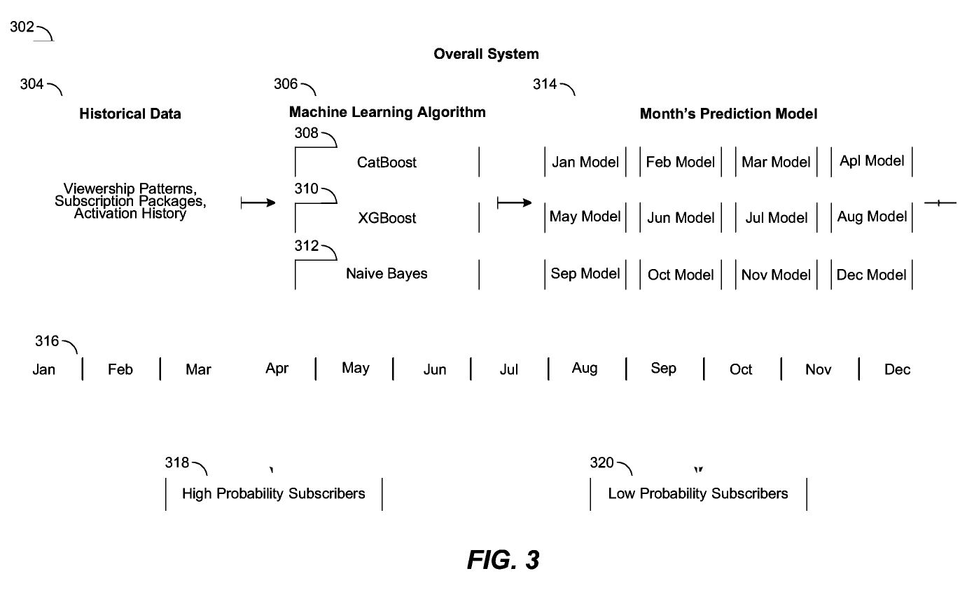

FIG. 3 illustrates an example process of generating and applying prediction models for different time periods. The figure shows a single panel diagram that demonstrates the various components and stages involved in creating and utilizing prediction models for subscriber reactivation prediction. This visualization may provide insights into the intricate process of transforming raw historical data into actionable predictions, potentially enabling more effective and targeted reactivation strategies.

The diagram displays a large rectangle representing the overall system 302. Within this rectangle 302, three vertical columns are arranged to depict the flow of data and processing through the system. These columns may represent different stages in the prediction model generation and application process, allowing for a clear visualization of how historical data may be transformed into actionable predictions. The leftmost column may be considered the input stage, the middle column the processing stage, and the rightmost column the output stage. This layout may facilitate a intuitive understanding of the system's workflow, potentially making it easier for stakeholders to grasp the end-to-end process of subscriber reactivation prediction.

In the left column of the diagram, a rectangle labeled "Historical Data" 304 is prominently displayed. This component may serve as the foundation for the entire prediction process, acting as the primary source of information from which the system may derive its insights. Below the "Historical Data" 304 rectangle, a list of data types is shown, including "Viewership Patterns," "Subscription Packages," and "Activation History." These categories may represent the diverse range of information that may be utilized in generating accurate prediction models. The historical data 304 may encompass a wide array of subscriber-related information, potentially including demographic data, past viewing habits, subscription duration, payment history, and/or reasons for previous cancellations. In some examples, this data may also include external factors such as market trends, competitive offerings, and/or seasonal patterns that may iNFXuence subscriber behavior. The comprehensive nature of this historical data 304 may allow for a more nuanced and accurate prediction of subscriber reactivation probabilities. Furthermore, the system may continuously update and refine this historical data, potentially incorporating real-time information to enhance the accuracy and relevance of its predictions. The ability to handle and process large volumes of diverse data may be a strength of this system, potentially enabling it to capture subtle patterns and correlations that might otherwise go unnoticed.

The middle column of the diagram features a large rectangle labeled "Machine Learning Algorithm" 306. This component may represent the computational engine that processes the historical data and generates the prediction models. Within the "Machine Learning Algorithm" 306 rectangle, three smaller rectangles are stacked vertically, labeled from top to bottom: "CatBoost" 308, "XGBoost" 310, and "Naive Bayes" 312. These may represent different machine learning algorithms that may be employed in the prediction process. The inclusion of multiple algorithms may suggest a flexible and/or adaptable system that can utilize different techniques based on their effectiveness for specific datasets or prediction tasks.

In some examples, the machine learning algorithms employed in the system may include CatBoost 308, XGBoost 310, and Naive Bayes 312. CatBoost 308 and XGBoost 310 are both specific implementations of gradient boosting algorithms, which fall under the broader category of tree-based decision algorithms. These gradient boosting techniques may excel at handling complex, non-linear relationships in data and may be particularly effective for categorical variables. Naive Bayes 312, on the other hand, is a probabilistic algorithm based on Bayes' theorem and may be categorized separately from tree-based methods. All three algorithms - CatBoost 308, XGBoost 310, and Naive Bayes 312 - may be considered specific types of machine learning algorithms, which is a more general term encompassing various computational techniques for pattern recognition and prediction. The system may utilize one or more of these algorithms, potentially selecting the most appropriate technique based on the specific characteristics of the data and the prediction task at hand. An arrow is shown pointing from the "Historical Data" 304 rectangle to the "Machine Learning Algorithm" 306 rectangle, indicating the flow of information from the data source to the processing stage. This visual representation may highlight the system's ability to leverage multiple algorithmic techniques, potentially enabling it to adapt to different data characteristics and prediction scenarios.

In some examples, the system may employ a combination of these algorithms, potentially using ensemble methods to leverage the strengths of each technique. The CatBoost 308 and/or XGBoost 310 algorithms may be particularly effective for handling categorical data and/or capturing complex, non-linear relationships in the historical data. These gradient boosting algorithms may excel at handling high-dimensional data and may be robust against overfitting, potentially improving the generalization capabilities of the prediction models. The Naive Bayes 312 algorithm, on the other hand, may offer computational efficiency and/or perform well with high-dimensional data, particularly in scenarios where features may be assumed to be independent. It may be especially useful for text classification tasks, such as analyzing customer feedback or subscription cancellation reasons. The system may dynamically select or weight these algorithms based on their performance, potentially adapting to changes in data patterns or prediction accuracy over time. This adaptive technique may allow the system to maintain high prediction accuracy even as subscriber behavior patterns evolve or new factors iNFXuencing reactivation emerge.

The right column of the diagram displays a grid of 12 small rectangles, each representing a month's prediction model 314. These rectangles are labeled "Jan Model," "Feb Model," etc., through "Dec Model." This arrangement may visualize how the system generates separate prediction models for each month of the year, allowing for time-specific predictions of subscriber restarts. An arrow is shown connecting the "Machine Learning Algorithm" 306 rectangle to this grid of models, illustrating the output of the machine learning process. The use of month-specific models may enable the system to capture and leverage temporal patterns in subscriber behavior, potentially improving the accuracy and relevance of its predictions throughout the year.

In some examples, these month-specific models 314 may capture seasonal trends, promotional periods, and/or other time-dependent factors that may iNFXuence a subscriber's likelihood of reactivation. For instance, the "Dec Model" may incorporate factors related to holiday promotions or end-of-year content releases, while the "Jun Model" may account for summer viewing patterns or mid-year subscription trends. This granular, time-based technique may allow for more precise and contextualized predictions throughout the year. The system may also consider the interplay between different monthly models, potentially identifying cross-month trends or patterns that span multiple periods. For example, it may detect that subscribers who cancel in December are more likely to reactivate in February, perhaps due to post-holiday financial recovery. Such insights may inform more sophisticated, long-term reactivation strategies that extend beyond single-month considerations.

Below the main rectangle 302, a horizontal timeline 316 is depicted, representing the overall time period. This timeline 316 is divided into 12 equal segments, each corresponding to a month. The presence of this timeline 316 may reinforce the time-specific nature of the prediction models and/or illustrate how the system may apply different models as time progresses. This visual element may help stakeholders understand the temporal dimension of the prediction process, potentially facilitating better planning and coordination of reactivation efforts throughout the year. The timeline 316 may also serve as a reference point for analyzing long-term trends or patterns in subscriber behavior, potentially revealing cyclical patterns or gradual shifts in reactivation tendencies over extended periods.

At the bottom of the figure, two rectangles are shown side by side. The left rectangle is labeled "High Probability Subscribers" 318, and the right rectangle is labeled "Low Probability Subscribers" 320. An arrow is drawn from the grid of month models 314 to these two rectangles, splitting into two near the end to point to both rectangles. This visualization may represent how the output of the prediction models is used to categorize subscribers based on their likelihood of reactivation. The binary categorization shown here may be a simplified representation of what could be a more nuanced segmentation in practice, potentially involving multiple probability tiers or even continuous probability scores.

In some examples, the system may use these categorizations to tailor marketing strategies and/or resource allocation. High probability subscribers 318 may receive different types of reactivation messages or offers compared to low probability subscribers 320. This segmentation may allow for more efficient and/or effective reactivation efforts, potentially optimizing the use of marketing resources and/or improving overall reactivation rates. The system might employ sophisticated targeting strategies, such as personalized content recommendations for high-probability subscribers or more aggressive incentives for those in the low-probability category. Furthermore, the categorization process may be dynamic, with subscribers potentially moving between categories based on changes in their behavior or external factors. This adaptability may enable the system to maintain relevance and effectiveness in its reactivation efforts over time, even as individual subscriber circumstances evolve.

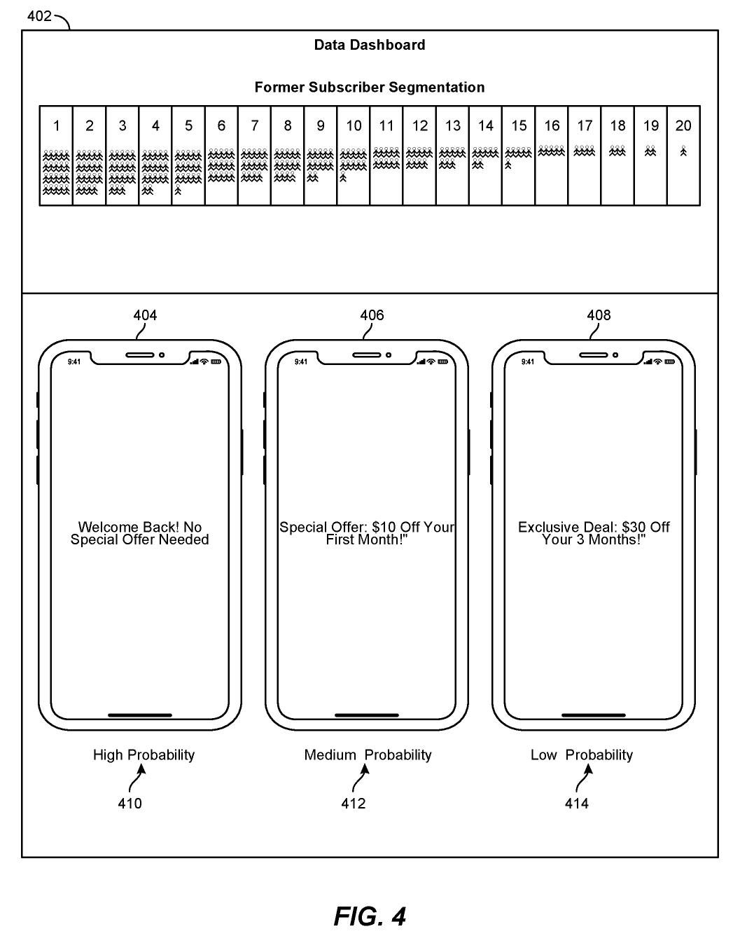

FIG. 4 demonstrates an example segmentation of former subscribers and application of targeted marketing strategies. The figure is divided into two panels: a top panel and a bottom panel, each illustrating different aspects of the subscriber segmentation and marketing process. This visualization may provide insights into how data-driven segmentation techniques may be applied to create more effective and personalized reactivation campaigns for former subscribers.

The top panel of FIG. 4 shows a large, rectangular screen representing a data dashboard 402. This dashboard 402 may be used by marketing professionals and/or data analysts to visualize and/or interact with subscriber segmentation data. The screen is divided into 20 equal vertical sections, representing ventiles. These ventiles may offer a more granular segmentation technique compared to quartiles and/or deciles, potentially allowing for more precise targeting of former subscribers. The leftmost section is labeled "1" and the rightmost section is labeled "20". Above the screen, the text "Former Subscriber Segmentation" is displayed, indicating the purpose of this visualization. The use of ventiles for segmentation may provide several advantages in the context of subscriber reactivation efforts. For example, this fine-grained segmentation may allow for more nuanced targeting strategies, potentially enabling marketers to tailor their messages and/or offers with greater precision. Additionally, the 20-segment technique may reveal subtle patterns and/or trends in subscriber behavior that might be obscured by broader segmentation techniques.

In each ventile section of the dashboard 402, stick figures representing subscribers are drawn. The distribution of these stick figures across the ventiles may provide a visual representation of how former subscribers are segmented based on their predicted probability of restarting their subscription. The number of stick figures in each ventile decreases from left to right, with more figures in the lower-numbered ventiles (e.g., 10 figures in ventile 1, 8 in ventile 2, etc.) and fewer in the higher-numbered ventiles (e.g., 1 figure in ventile 20, 2 in ventile 19, etc.). This distribution may illustrate that a larger number of former subscribers fall into the higher probability segments, while fewer are categorized in the lower probability segments. The visual representation of subscriber distribution may offer several benefits to marketing teams and/or data analysts. For instance, it may provide an immediate, intuitive understanding of the overall composition of the former subscriber base, potentially highlighting opportunities for targeted reactivation efforts. Furthermore, the decreasing number of figures from left to right may suggest a natural prioritization of marketing resources, with more attention potentially being directed towards the higher-probability segments.

In some examples, the ventile segmentation technique may allow for highly targeted marketing strategies. The system may use this granular segmentation to tailor reactivation messages, offers, and/or timing based on the specific characteristics of each ventile. For instance, subscribers in the first few ventiles may receive minimal or no incentives, as they may be likely to reactivate without additional prompting. Conversely, subscribers in the middle ventiles may receive moderate offers, while those in the highest-numbered ventiles may be targeted with more substantial incentives to encourage reactivation. This tailored technique may lead to more efficient use of marketing resources and/or potentially higher conversion rates across different subscriber segments. Additionally, the ventile technique may enable more sophisticated A/B testing and/or optimization strategies, allowing marketers to fine-tune their techniques for each segment independently. The system may also incorporate dynamic segmentation, where subscribers may move between ventiles based on changes in their behavior and/or external factors, ensuring that the targeting remains relevant and/or effective over time.

The bottom panel of FIG. 4 illustrates how the segmentation data may be applied to create targeted marketing strategies. This panel shows three simplified smartphone screens side by side (404, 406, 408), each displaying a different marketing message. These smartphone screens may represent the various ways in which reactivation messages could be delivered to former subscribers, such as through mobile apps, text messages, and/or email notifications viewed on a mobile device. The use of smartphone screens in this visualization may reflect the increasing importance of mobile communications in marketing strategies and/or the potential for delivering personalized, timely messages directly to former subscribers' devices. The different messages displayed on each screen may demonstrate how the content and/or tone of reactivation efforts may be tailored based on the subscriber's predicted likelihood of returning to the service.

The first smartphone screen 404 shows a message that says "Welcome back! No special offer needed." This message may be targeted at high-probability subscribers who are likely to reactivate without additional incentives. The straightforward nature of this message may appeal to subscribers who are already inclined to return to the service, potentially saving marketing resources that might otherwise be spent on unnecessary offers. For these high-probability subscribers, the focus may be on reminding them of the value they previously received from the service and/or highlighting new content and/or features that may have been added since their subscription lapsed. The system may also experiment with different tones and/or messaging styles for this segment, potentially testing whether a more casual and/or personalized welcome message may be more effective than a formal one.

The second smartphone screen 406 displays a message saying "Special offer: $10 off your first month!" This moderate offer may be aimed at subscribers in the middle probability range, providing a small incentive that could tip the scales in favor of reactivation. The specific amount and/or duration of the offer may be adjusted based on data-driven insights about what motivates this particular segment of former subscribers. For this middle segment, the system may employ more varied and/or sophisticated marketing techniques. For example, it may test different discount amounts, offer durations, and/or bundled incentives to determine the most effective combination for driving reactivations. The system may also incorporate personalized content recommendations and/or highlight specific features that align with the subscriber's past usage patterns, potentially increasing the perceived value of reactivation.

The third smartphone screen 408 shows a message reading "Exclusive deal: $30 off for 3 months!" This more substantial offer may be targeted at low-probability subscribers who may need a stronger incentive to consider reactivating their subscription. The larger discount and/or longer duration of this offer may reflect the greater effort required to win back subscribers who are less likely to return on their own. For these low-probability subscribers, the marketing technique may extend beyond simple discounts. The system may explore multi-faceted reactivation campaigns that combine financial incentives with personalized content recommendations, extended free trials, and/or exclusive access to premium features. Additionally, the messaging for this segment may focus more heavily on addressing potential reasons for the initial cancellation, such as highlighting improvements in content libraries, streaming quality, and/or user experience.

In some examples, the system may dynamically adjust the content and/or targeting of these marketing messages based on real-time data and/or performance metrics. The messages may be personalized not only based on the probability of reactivation but also on factors such as the subscriber's past viewing habits, preferred genres, and/or reasons for initially canceling their subscription. This level of personalization may increase the relevance and/or effectiveness of the reactivation efforts. The system may employ machine learning algorithms to continuously refine its personalization techniques, potentially identifying complex patterns and/or correlations that may not be immediately apparent to human marketers. For instance, it may discover that certain combinations of content recommendations and/or offer structures are particularly effective for specific sub-segments within each probability group, allowing for even more targeted and/or effective reactivation campaigns.

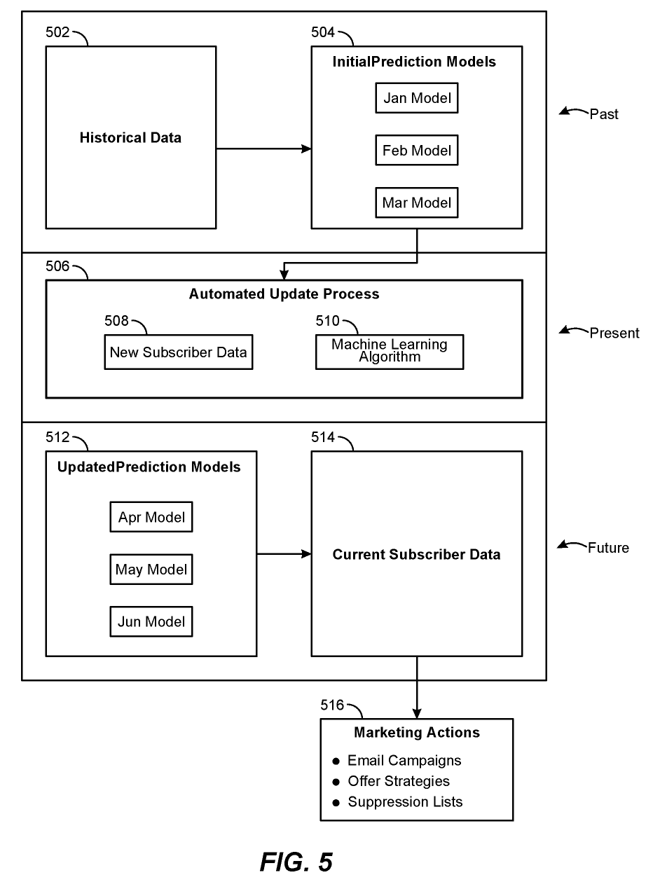

FIG. 5 depicts an example automated process of updating prediction models and applying them to current data. The figure is divided into three horizontal sections representing different time periods: Past, Present, and Future. This layout may illustrate the continuous nature of the prediction model updating process and how it may evolve over time to maintain accuracy and/or relevance. The temporal division of the figure into past, present, and future sections may provide a clear visualization of the system's ability to learn from historical data, adapt to current conditions, and/or generate forward-looking predictions. This structure may also emphasize the iterative nature of the model updating process, potentially highlighting how insights gained from each cycle may inform and/or improve subsequent iterations.

In the top section, labeled Past, a rectangle labeled Historical Data 502 is shown on the left side. This historical data 502 may include a wide range of information about former subscribers, such as their viewing habits, subscription history, demographic information, and/or reasons for previous cancellations. The system may continuously update and/or refine this historical data 502, potentially incorporating new information as it becomes available. To the right of the historical data 502, a larger rectangle labeled Initial Prediction Models 504 is displayed. Inside this rectangle 504, three smaller rectangles are stacked vertically, labeled from top to bottom: Jan Model, Feb Model, and Mar Model. These may represent the initial set of prediction models generated based on the historical data 502. An arrow is drawn from the Historical Data 502 rectangle to the Initial Prediction Models 504 rectangle, indicating the flow of information from the data source to the model generation process. The use of monthly models may allow for more precise predictions that account for seasonal trends and/or other time-specific factors that may iNFXuence subscriber behavior. The visualization of multiple monthly models within the Initial Prediction Models 504 rectangle may suggest that the system recognizes and/or accounts for temporal variations in subscriber behavior, potentially allowing for more nuanced and/or accurate predictions throughout the year.

In some examples, the system may generate these initial prediction models 504 using various machine learning algorithms, such as gradient boosting techniques and/or neural networks. The choice of algorithm may depend on the specific characteristics of the data and/or the desired prediction outcomes. The system may also employ ensemble methods, combining multiple algorithms to potentially improve prediction accuracy and/or robustness. The monthly granularity of the models may allow for the capture of subtle temporal patterns in subscriber behavior, which may be particularly useful for services with strong seasonal components, such as sports streaming platforms and/or educational content providers. Additionally, the system may implement techniques for handling imbalanced datasets, as the number of former subscribers who reactivate may be significantly smaller than those who do not. This may involve methods such as oversampling minority classes, undersampling majority classes, and/or generating synthetic samples to balance the dataset.

The middle section, labeled Present, features a large rectangle in the center labeled Automated Update Process 506. This component may represent the core of the system's adaptive capabilities, continuously refining the prediction models based on new data and/or changing market conditions. Inside the Automated Update Process 506 rectangle, two side-by-side smaller rectangles are shown: one labeled New Subscriber Data 508 and the other labeled Machine Learning Algorithm 510. An arrow is drawn from the Initial Prediction Models 504 in the top section to the Automated Update Process 506 rectangle, indicating that the initial models may serve as a starting point for the ongoing refinement process. The placement of the Automated Update Process 506 in the center of the figure may emphasize its role as a bridge between past insights and/or future predictions, potentially highlighting the dynamic and/or adaptive nature of the system.

In some examples, the New Subscriber Data 508 component may include recent information about subscriber behavior, market trends, and/or external factors that may iNFXuence reactivation probabilities. This data may be collected in real-time and/or at regular intervals, ensuring that the update process remains responsive to changing conditions. The system may employ various data collection techniques, such as user interaction tracking, survey responses, and/or integration with external data sources, to gather comprehensive and/or relevant information for model updating. The system may also implement data quality checks and/or preprocessing steps to ensure that the new data is consistent, accurate, and/or suitable for model training. This may involve techniques such as outlier detection, missing value imputation, and/or feature scaling to maintain the integrity and/or reliability of the input data.

The Machine Learning Algorithm 510 component may represent the computational techniques used to process the new data and/or update the prediction models. This may involve retraining the existing models with the new data, fine-tuning model parameters, and/or potentially switching to different algorithms if they prove more effective. The system may use techniques such as online learning and/or incremental learning to efficiently incorporate new data without the need for complete model retraining. Additionally, the system may employ automated hyperparameter tuning techniques to optimize the performance of the machine learning algorithms over time. The system may also implement regularization techniques to prevent overfitting, especially when dealing with limited amounts of new data. This may help ensure that the updated models generalize well to unseen data and/or maintain their predictive power across different subscriber segments.

In the bottom section, labeled Future, the outcomes of the automated update process are illustrated. On the left side, a rectangle labeled Updated Prediction Models 512 is shown. Similar to the initial models in the top section, this rectangle 512 includes three smaller rectangles inside, labeled Apr Model, May Model, and Jun Model. This representation indicates that the system continues to maintain month-specific models, but with updated parameters and/or structures based on the latest data and learning outcomes. To the right of the updated models 512, another rectangle labeled Current Subscriber Data 514 is displayed. An arrow is drawn from the Updated Prediction Models 512 to the Current Subscriber Data 514 rectangle, indicating that the refined models are applied to the most recent subscriber information. This process may allow the system to generate up-to-date predictions that reflect both historical patterns and/or current market conditions.

At the far right of the bottom section, a rectangle labeled Marketing Actions 516 is shown. Inside this rectangle 516, a list of potential actions is displayed in text form: Email Campaigns, Offer Strategies, Suppression Lists. An arrow is drawn from the Current Subscriber Data 514 rectangle to the Marketing Actions 516 rectangle, illustrating how the predictions generated by applying the updated models to current data may inform specific marketing strategies. This final step in the process may demonstrate how the insights gained from the prediction models may be translated into actionable marketing initiatives, potentially improving the effectiveness of subscriber reactivation efforts.

In some examples, the system may use the outputs of the updated prediction models 512 to dynamically adjust marketing strategies in real-time. This may involve automatically generating personalized email content, determining optimal offer structures for different subscriber segments, and/or identifying subscribers who may be less receptive to reactivation attempts and should be temporarily excluded from marketing campaigns. The system may also integrate with other marketing automation tools, potentially allowing for seamless execution of the recommended actions across various channels and/or platforms. This integration may enable a more cohesive and/or responsive marketing technique that adapts quickly to changing subscriber behaviors and/or market conditions.

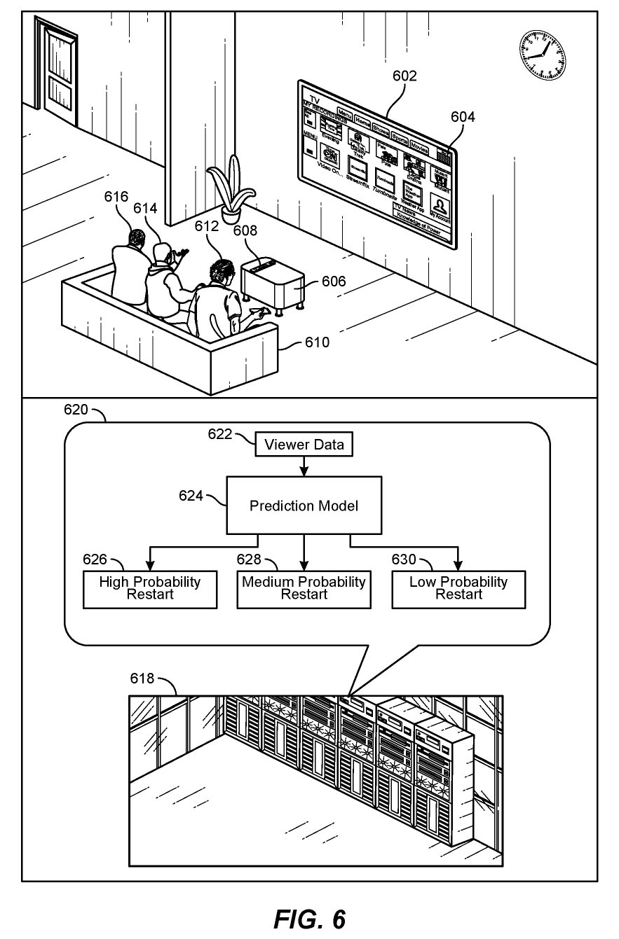

FIG. 6 illustrates an example real-world application of the prediction model system in a streaming service context. The figure is divided into two panels: a top panel and a bottom panel, each depicting different aspects of the subscriber reactivation process and the underlying predictive technology. The top panel may provide a visual representation of the user-facing elements of a streaming service, while the bottom panel may illustrate the backend processes that drive personalized recommendations and reactivation strategies. This dual representation may highlight the interconnected nature of user experience and data-driven decision making in modern streaming platforms, potentially demonstrating how advanced prediction models may seamlessly integrate into everyday viewing scenarios.

In the top panel, a large, wall-mounted flat-screen TV 602 is shown displaying a streaming service interface. This interface presents a grid of TV show thumbnails, which may resemble layouts commonly found in popular streaming platforms. The variety of thumbnails displayed may reflect the diverse content offerings that streaming services may use to attract and/or retain subscribers. The arrangement and selection of these thumbnails may not be random; instead, they may be carefully curated based on viewing histories, predicted preferences, and/or current trends identified by the prediction model system. In the top-right corner of the TV screen 602, a small calendar icon 604 is visible, showing the current month. This calendar icon 604 may serve multiple purposes within the streaming interface, such as highlighting upcoming content releases, reminding users of subscription renewal dates, and/or providing a visual cue for time-sensitive offers and/or promotions. The presence of this calendar element may also subtly reinforce the time-based nature of the prediction models, potentially aligning visible user interface elements with the underlying temporal aspects of the prediction system. The system may use this calendar feature to time the display of personalized content recommendations or reactivation offers, aligning them with periods when users may be more likely to engage or resubscribe based on historical patterns or predicted behavior.

The top panel also depicts a living room setting, with a coffee table 606 positioned in front of the TV 602. On the coffee table 606, a remote control 608 is placed, suggesting readiness for user interaction with the streaming service. The prominence of the remote control 608 may indicate the importance of user engagement and control in the streaming experience. The system may track interactions via the remote control 608, such as content browsing patterns, pause and rewind frequency, or time spent on different sections of the interface, to gather data for the prediction model. This data may be used to refine user profiles and improve the accuracy of reactivation probability predictions. Behind the coffee table 606, a couch 610 is shown with three people sitting on it, each exhibiting different behaviors that may represent various stages of engagement with the streaming service and/or potential for reactivation. These diverse user behaviors may illustrate the complex nature of viewer engagement and the need for sophisticated prediction models to interpret and respond to a wide range of user interactions. The scene may also highlight the social aspect of content consumption, suggesting that prediction models may need to account for household dynamics and/or shared viewing experiences in addition to individual user data. The system may analyze patterns of group viewing behavior to identify content that appeals to multiple household members, potentially increasing overall engagement and reducing the likelihood of subscription cancellation.

The first person 612 on the couch 610 is shown holding a smartphone, looking engaged with the device. This scenario may represent a user who is actively interacting with the streaming service's mobile application, perhaps browsing content, managing their account, and/or responding to personalized reactivation offers. The smartphone usage may also indicate the importance of multi-platform accessibility in modern streaming services, where users may seamlessly transition between devices. The engagement of this user with a mobile device may suggest that prediction models may need to incorporate cross-platform usage data to generate more accurate reactivation probabilities. Additionally, the simultaneous use of a smartphone while in front of a TV may indicate opportunities for second-screen experiences or complementary content recommendations that could enhance user engagement and increase the likelihood of subscription retention or reactivation. The system may analyze data from both the TV and mobile app interactions to create a more comprehensive user profile, potentially identifying patterns that indicate a higher or lower probability of subscription reactivation.

The second person 614 is depicted pointing at the TV screen 602, as if discussing a show. This behavior may illustrate the social aspect of content consumption and how word-of-mouth recommendations and/or shared viewing experiences may iNFXuence subscription decisions. The animated discussion may also suggest engagement with the content offerings, which may be a positive indicator for potential reactivation or continued subscription. The interaction between this person and the content on the screen may provide valuable data points for the prediction model, potentially indicating strong engagement and a higher likelihood of subscription retention or reactivation. The system may use this type of behavioral data to refine its predictions and tailor content recommendations not just for individuals, but for household units or social groups that may iNFXuence each other's viewing habits and subscription decisions. In some examples, the prediction model may incorporate social network analysis techniques to identify iNFXuential users within a household or friend group, potentially targeting these users with specific reactivation strategies that may have a ripple effect on connected users.

The third person 616 is not significantly engaging with the TV or others. This individual may represent a less engaged or former subscriber who may be a target for reactivation efforts. Their neutral stance may suggest an opportunity for the streaming service to re-capture their interest through personalized content recommendations and/or tailored reactivation offers. The prediction model may identify users exhibiting similar behavior patterns and categorize them as higher-risk for churn or less likely to reactivate without significant incentives. This information may then be used to develop targeted marketing strategies or content curation efforts specifically designed to re-engage users showing signs of disinterest. The model may also analyze historical data to identify factors that previously led to increased engagement for users with similar behavior patterns, potentially informing more effective reactivation strategies. In some scenarios, the system may experiment with different types of content recommendations or interface designs for users displaying this level of disengagement, tracking the effectiveness of various approaches to refine its reactivation techniques over time.

In the bottom panel of FIG. 6, a simplified representation of a data center or server room 618 is illustrated. This visualization may depict the backend infrastructure supporting the prediction model system. The server room 618 includes several server racks with blinking lights, representing active processing. This visual element may convey the complex computational resources required to analyze subscriber data, generate predictions, and/or deliver personalized content and offers in real-time. The scale and complexity of the server room 618 may underscore the sophisticated nature of the prediction model system and its ability to process vast amounts of data quickly and efficiently. The continuous operation suggested by the blinking lights may also indicate the real-time nature of the prediction and recommendation processes, highlighting the system's ability to adapt to changing user behaviors and preferences on an ongoing basis. In some implementations, the system may utilize distributed computing techniques, allowing it to scale its processing capabilities dynamically based on current demand and the complexity of the prediction tasks at hand.

Above the server room 618, a thought bubble 620 is drawn, containing elements that represent the data processing and prediction workflow. Within this thought bubble 620, a small rectangle labeled Viewer Data 622 is shown. This component may represent the aggregated information collected from subscribers' viewing habits, interaction patterns, and/or account histories. The viewer data 622 may serve as the foundation for generating accurate predictions about subscriber behavior and/or reactivation likelihood. This data may be continuously updated and refined as users interact with the streaming service across various devices and platforms.

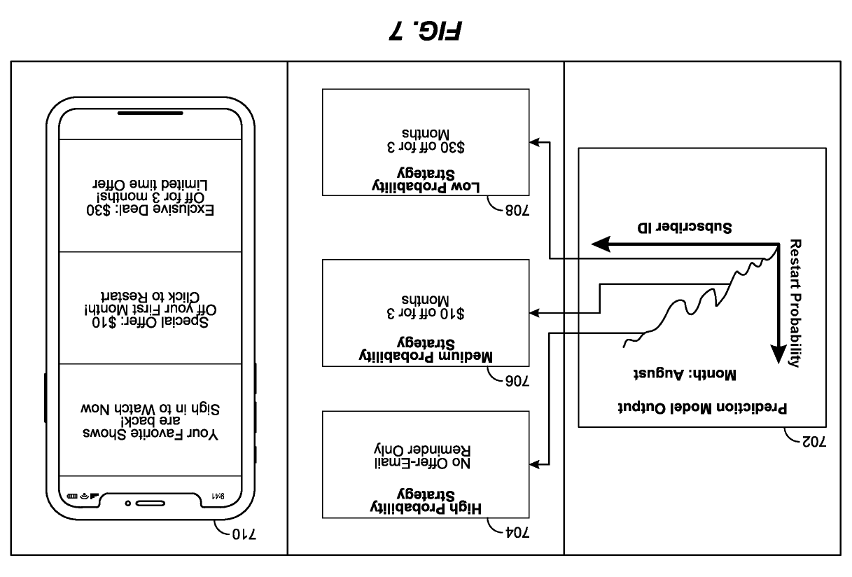

FIG. 7 illustrates an example schematic diagram depicting the process of determining and/or applying marketing strategies based on prediction model outputs. The figure is divided into three vertical sections, each representing a different stage in the process of translating model predictions into actionable marketing strategies. This layout may provide a clear visualization of the workflow from raw prediction data to targeted customer communications, potentially highlighting the system's ability to transform complex statistical outputs into practical, personalized marketing efforts. The three-section structure may also emphasize the modular nature of the system, where each component may be independently optimized and/or updated without necessarily affecting the others, potentially allowing for greater flexibility and/or scalability in the overall marketing technique.

In the left section of FIG. 7, a large rectangle labeled Prediction Model Output 702 is shown. Inside this rectangle, a vertical line graph is displayed, with the x-axis labeled Subscriber ID and the y-axis labeled Restart Probability. The line on the graph shows variations in probability across different subscriber IDs, potentially representing the diverse range of reactivation likelihoods within a former subscriber base. Above the graph, the text Month: August is added, which may indicate that these predictions are specific to a particular time period. This temporal specificity may allow for more targeted and/or timely marketing efforts, as subscriber behavior and/or reactivation likelihood may vary throughout the year. The variation in the line graph may reflect the complexity of factors iNFXuencing reactivation probabilities, such as past viewing habits, subscription history, and/or external market conditions. In some examples, the system may generate these probability scores by aggregating outputs from multiple prediction models, each focusing on different aspects of subscriber behavior and/or market trends. The granularity of the subscriber ID axis may allow for highly personalized marketing strategies, potentially enabling the system to tailor its techniques to individual subscriber preferences and/or behaviors. Additionally, the system may employ advanced data visualization techniques to present this information in a more interactive and/or intuitive format for marketing teams, potentially allowing for real-time exploration of subscriber segments and/or trend analysis. The prediction model output 702 may also incorporate confidence intervals or uncertainty metrics for each probability estimate, providing a more nuanced view of the prediction reliability and/or potentially informing risk-adjusted marketing strategies.

The middle section of FIG. 7 displays three rectangles stacked vertically, each representing a different marketing strategy based on the predicted restart probabilities. This segmentation technique may allow for more efficient resource allocation and/or tailored communication strategies, potentially maximizing the effectiveness of reactivation efforts across diverse subscriber groups. The top rectangle is labeled High Probability Strategy 704, and inside it, the text No offer - Email reminder only is written. This strategy may be applied to subscribers who are deemed highly likely to restart their subscriptions without significant incentives. By avoiding unnecessary offers for this group, the system may optimize resource allocation and/or potentially increase overall campaign efficiency. The content of these email reminders may be carefully crafted to highlight new content additions, service improvements, and/or upcoming releases that align with the subscriber's past preferences, potentially nudging them towards reactivation without the need for financial incentives. In some scenarios, the system may further segment this high-probability group based on factors such as predicted lifetime value or past engagement levels, potentially allowing for even more refined communication strategies. For instance, highly engaged former subscribers within this group may receive personalized content recommendations or exclusive previews, while those with lower historical engagement may receive broader service highlights or improved user experience messaging.

The middle rectangle in this section is labeled Medium Probability Strategy 706, with the text $10 off first month written inside. This strategy may target subscribers who show moderate likelihood of restarting but may benefit from a small incentive to take action. The specific discount amount may be determined through a combination of historical data analysis and/or real-time market conditions, potentially optimizing the balance between offer attractiveness and/or company profitability. In some implementations, the system may dynamically adjust this offer based on factors such as the subscriber's past responsiveness to promotions, current market competition, and/or the predicted lifetime value of the subscriber. The medium probability segment may also be subject to more extensive A/B testing or multivariate optimization techniques, as it may represent the group with the highest potential for conversion improvement through refined messaging and/or offer structures. The system may experiment with various incentive types beyond simple discounts, such as extended trial periods, bundled services, or personalized content packages, potentially identifying the most effective reactivation levers for different subscriber profiles within this segment.

The bottom rectangle is labeled Low Probability Strategy 708, containing the text $30 off for 3 months. This more substantial offer may be designed for subscribers who are least likely to restart based on the model predictions. The extended duration and/or higher value of this offer may reflect the greater effort required to re-engage this segment of former subscribers. The system may carefully weigh the costs of such offers against the potential long-term value of reactivating these subscribers, potentially considering factors such as their past engagement levels, content preferences, and/or the likelihood of sustained subscription post-reactivation. In some examples, the low probability strategy may incorporate a multi-touch technique, where the initial offer is followed by a series of carefully timed follow-up communications, each potentially adjusting the incentive or messaging based on the subscriber's responses or lack thereof. This segment may also be a prime candidate for more innovative reactivation techniques, such as gamified offers, referral bonuses, or partnerships with complementary services, potentially exploring novel ways to re-engage the most resistant former subscribers.

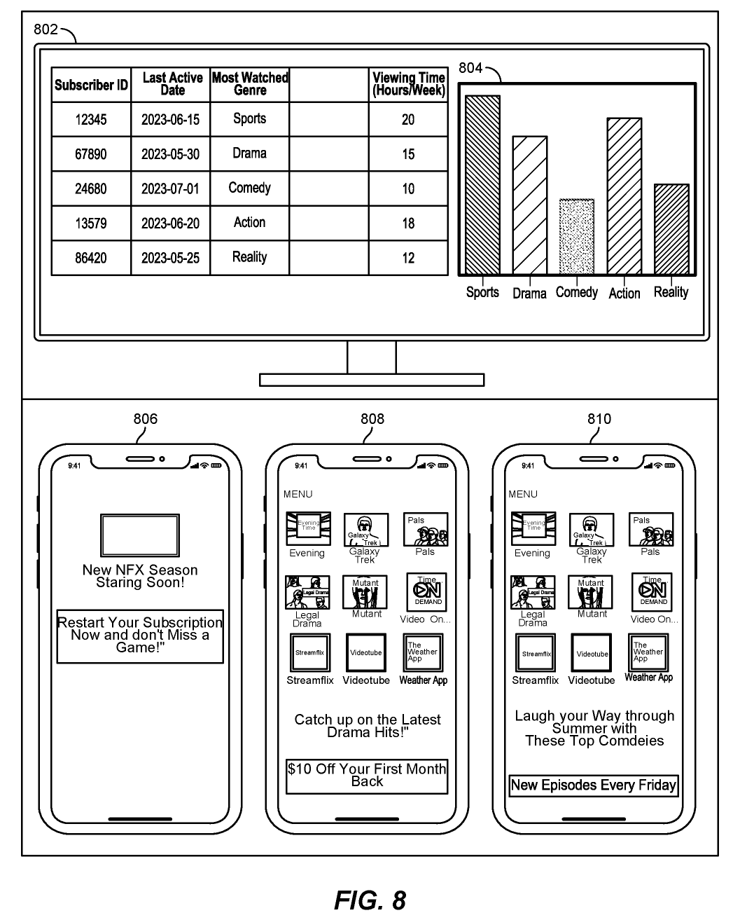

FIG. 8 illustrates an example real-world representation of the process of content recommendation based on historical viewership data. The figure is divided into two panels: a top panel and a bottom panel, each depicting different aspects of the data analysis and personalized content recommendation process. This dual-panel layout may provide a comprehensive view of how raw subscriber data may be transformed into targeted, user-specific content recommendations, potentially highlighting the seamless integration of backend data processing and frontend user experience in modern streaming platforms.

In the top panel, a large computer monitor 802 is shown displaying a data analysis interface. This interface may provide a visual representation of the example complex data processing and analysis techniques used to generate personalized content recommendations. The monitor 802 displays a table with several columns, including Subscriber ID, Last Active Date, Most Watched Genre, Favorite Show, and Viewing Time (hours/week). This tabular format may allow for easy comparison and analysis of subscriber viewing habits and preferences. The system may use this structured data to identify patterns and/or trends across different subscriber segments, potentially informing more targeted content recommendations and/or reactivation strategies. In some examples, the data displayed on the monitor 802 may be updated in real-time, reflecting the most recent subscriber interactions and/or viewing behaviors. This real-time data processing capability may enable more responsive and/or timely content recommendations, potentially increasing the relevance and/or effectiveness of reactivation efforts. The system may also employ advanced data visualization techniques to present this information in more interactive and/or intuitive formats, such as heat maps, network graphs, and/or multidimensional scatterplots, potentially allowing marketing teams to gain deeper insights into subscriber behavior patterns and/or content preferences.

The table on the monitor 802 is populated with sample data for five subscribers, providing a snapshot of diverse viewing habits and preferences. For instance, the first row shows a subscriber with ID 12345, last active on 2023-06-15, with a preference for Sports content, and an average viewing time of 20 hours per week. This level of detail may allow the system to create highly personalized content recommendations and/or reactivation strategies tailored to each subscriber's specific interests and/or viewing patterns. The variation in genres and viewing times across the sample data may highlight the importance of a flexible and adaptive recommendation system capable of catering to a wide range of viewer preferences and/or behaviors. In some scenarios, the system may employ machine learning algorithms to cluster subscribers based on these multidimensional data points, potentially identifying micro-segments with unique content preferences and/or viewing habits. These micro-segments may then be used to fine-tune content recommendations and/or marketing strategies, potentially increasing the relevance and/or effectiveness of reactivation efforts across diverse subscriber groups.

To the right of the table, a simple bar chart 804 is drawn, showing Most Popular Genres with bars for Sports, Drama, Comedy, Action, and Reality. This visual representation may provide a quick overview of content popularity across the subscriber base, potentially informing content acquisition decisions and/or marketing strategies. The relative heights of the bars may indicate the distribution of viewer preferences, with taller bars suggesting more popular genres. In some scenarios, this genre popularity data may be used in conjunction with individual subscriber preferences to create a balanced content recommendation strategy that considers both personal tastes and broader trends. The system may also implement dynamic genre categorization techniques, potentially allowing for the discovery of emerging sub-genres and/or cross-genre preferences that may not be immediately apparent from traditional genre classifications. This nuanced understanding of content categorization may enable more sophisticated recommendation algorithms, potentially identifying unexpected content matches that may resonate with specific subscriber segments.

The bottom panel of FIG. 8 showcases three smartphones side by side (806, 808, 810), each displaying a personalized content recommendation screen. This visualization may demonstrate how the data analysis from the top panel translates into tailored user experiences on mobile devices. The use of smartphones in this representation may highlight the importance of multi-platform accessibility in modern streaming services, potentially enabling subscribers to engage with personalized content recommendations across various devices and/or viewing contexts. In some examples, the system may employ responsive design techniques to optimize the presentation of content recommendations across different screen sizes and/or device types, potentially ensuring a consistent and engaging user experience regardless of the subscriber's preferred viewing platform. The system may also leverage device-specific features, such as push notifications and/or widgets, to deliver timely and contextually relevant content recommendations, potentially increasing the likelihood of reactivation and/or sustained engagement.

The first smartphone 806 displays a sports-themed interface with the text New NFX season starting soon! This personalized recommendation may be based on the viewing history of a subscriber similar to the one shown in the first row of the data table, who demonstrated a strong preference for sports content, particularly NFX Live. Below this main message, a small text box says Restart your subscription now and don't miss a game! This call-to-action may be designed to create a sense of urgency and/or relevance, potentially motivating sports enthusiasts to reactivate their subscriptions in time for the new season. In some scenarios, the system may incorporate real-time sports data feeds to enhance these recommendations, potentially highlighting upcoming matches featuring the subscriber's favorite teams and/or players. The system may also analyze historical viewing patterns to identify optimal times for delivering these sports-related recommendations, such as during pre-season periods and/or major sporting events, potentially maximizing the impact of reactivation messages for sports-focused subscribers.

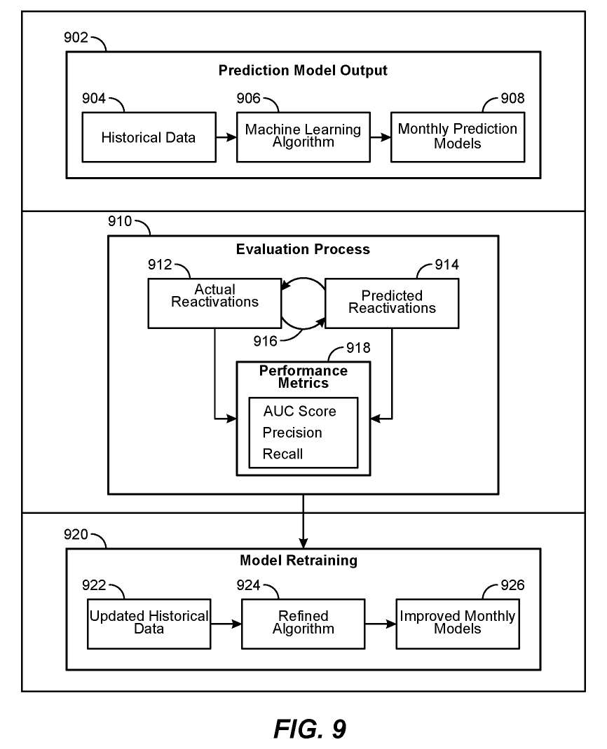

FIG. 9 illustrates a schematic diagram depicting the process of model evaluation and retraining. The figure is divided into three main sections arranged vertically, each representing a different stage in the continuous improvement cycle of the prediction model system. This layout may provide a clear visualization of how the system may adapt and refine its predictions over time, potentially enhancing its accuracy and effectiveness in subscriber reactivation efforts.

In the top section of FIG. 9, a large rectangle labeled Prediction Model System 902 is shown. Inside this rectangle, three smaller rectangles are arranged horizontally, labeled from left to right: Historical Data 904, Machine Learning Algorithm 906, and Monthly Prediction Models 908. Arrows connect these rectangles in sequence from left to right, potentially indicating the flow of information through the system. The Historical Data 904 component may represent the vast repository of subscriber information, viewing habits, and past subscription patterns that form the foundation of these specific examples of prediction models. This data may be continuously updated and expanded, potentially incorporating new sources of information to enhance the system's predictive capabilities. The Machine Learning Algorithm 906 may represent the computational engine that processes the historical data and generates the prediction models. This component may employ various techniques such as neural networks, decision trees, and/or ensemble methods to identify complex patterns and relationships within the data. The Monthly Prediction Models 908 may represent the output of the machine learning process, with separate models potentially generated for each month to account for seasonal variations and/or temporal trends in subscriber behavior. In some examples, the system may implement a federated learning technique, allowing for the creation of these models while maintaining data privacy and/or security. This technique may enable the incorporation of data from multiple sources and/or regions without centralizing sensitive subscriber information.

The middle section of FIG. 9 features a large rectangle labeled Evaluation Process 910. Within this rectangle, several elements are arranged to depict the model evaluation workflow. On the left side, a rectangle labeled Actual Reactivations 912 is shown, while on the right side, a rectangle labeled Predicted Reactivations 914 is displayed. These components may represent the comparison between the model's predictions and the observed outcomes, a step in assessing model performance. In the center, a circular arrow 916 connects these two rectangles, indicating the comparison process. This visual representation may highlight the iterative nature of model evaluation, where predicted and actual results are continuously compared to refine the system's accuracy. Below the circular arrow, a rectangle labeled Performance Metrics 918 is drawn. Inside this rectangle, a list of metrics is shown: AUC Score, Precision, and Recall. These metrics may provide a comprehensive assessment of the model's performance across various dimensions, potentially allowing for a nuanced understanding of its strengths and weaknesses. In some scenarios, the system may employ advanced visualization techniques to present these performance metrics, such as ROC curves and/or precision-recall plots, potentially enabling a more intuitive interpretation of model performance across different prediction thresholds. The system may also implement automated alerting mechanisms to flag significant deviations in these performance metrics, potentially enabling rapid identification and/or resolution of issues that may impact prediction accuracy.

Arrows are drawn from both the Actual Reactivations 912 and Predicted Reactivations 914 rectangles to the Performance Metrics 918 rectangle, indicating that both sets of data contribute to the calculation of these metrics. This workflow may illustrate how the system continuously evaluates its performance, potentially identifying areas for improvement and/or refinement. In some examples, the evaluation process may incorporate techniques such as cross-validation and/or bootstrapping to provide more robust estimates of model performance, potentially reducing the impact of sampling variability and/or outliers on the assessment of model accuracy. The system may also implement techniques for detecting and/or mitigating concept drift, where the relationship between input features and target variables may change over time, potentially ensuring that the models remain relevant and/or accurate in dynamic market conditions.

The bottom section of FIG. 9 contains a large rectangle labeled Model Retraining 920. Inside this rectangle, three elements are arranged horizontally: Updated Historical Data 922 on the left, Refined Algorithm 924 in the center, and Improved Monthly Models 926 on the right. Arrows connect these elements from left to right, potentially indicating the flow of information in the retraining process. The Updated Historical Data 922 component may represent the incorporation of new subscriber information and/or reactivation outcomes into the existing dataset, potentially enriching the foundation for model training. The Refined Algorithm 924 may represent the iterative improvement of the machine learning techniques used to generate the prediction models, potentially incorporating insights gained from the evaluation process to enhance predictive accuracy. The Improved Monthly Models 926 may represent the output of the retraining process, potentially offering more accurate and/or nuanced predictions of subscriber reactivation probabilities. In some scenarios, the system may employ transfer learning techniques to leverage knowledge gained from one monthly model to improve the performance of models for other months, potentially accelerating the learning process and/or enhancing overall system performance.

A large arrow is drawn from the Evaluation Process 910 rectangle to the Model Retraining 920 rectangle, illustrating how the insights gained from performance evaluation may inform and drive the retraining process. This connection may highlight the cyclical and continuous nature of model improvement, where performance metrics may be consistently used to refine and enhance the prediction system. In some examples, the system may implement a multi-objective optimization technique in the retraining process, potentially balancing multiple performance criteria such as accuracy, computational efficiency, and/or interpretability. This technique may allow for the creation of models that not only provide accurate predictions but also meet other operational requirements and/or constraints. The system may also incorporate techniques for model explainability, such as SHAP (SHapley Additive exPlanations) values and/or LIME (Local Interpretable Model-agnostic Explanations), potentially providing insights into the factors driving predictions and/or facilitating trust and understanding among stakeholders.

In some examples, the system may implement an automated model selection technique, where multiple model architectures and/or hyperparameter configurations are evaluated during the retraining process. This technique may leverage techniques such as Bayesian optimization and/or genetic algorithms to efficiently explore the space of possible models, potentially identifying optimal configurations that may not be apparent through manual tuning. The system may also incorporate ensemble methods in the retraining process, potentially combining predictions from multiple models to create a more robust and/or accurate final prediction. These ensemble techniques may include methods such as bagging, boosting, and/or stacking, potentially leveraging the strengths of different model types to improve overall system performance.

The above provided a comprehensive overview of the figures. Additionally, the following discussions provide supplemental detail regarding various additional and/or alternative embodiments in terms of concrete implantation details.

In some examples, the system may employ a combination of machine learning algorithms to generate highly accurate prediction models for subscriber reactivation. These algorithms may include gradient boosting techniques such as CatBoost and XGBoost, as well as probabilistic methods like Naive Bayes. Each of these algorithms may offer unique strengths that may be leveraged in different aspects of the prediction process. XGBoost, for instance, may excel at handling large-scale datasets and may be particularly effective at capturing complex interactions between features. Its ability to perform parallel processing may enable faster training times, which may be advantageous when dealing with the large volumes of historical data 218 shown in FIG. 2. XGBoost's regularization techniques may help prevent overfitting, potentially leading to more generalizable models that perform well across different subscriber segments. Naive Bayes, on the other hand, may offer computational efficiency and may be particularly useful for text classification tasks, such as analyzing subscriber feedback or categorizing content preferences. Its probabilistic nature may provide intuitive probability estimates, which may be valuable when generating the subscriber restart probabilities 224 depicted in FIG. 2. Naive Bayes may also perform well with high-dimensional data, potentially allowing for the incorporation of a wide range of features from the historical data 304 shown in FIG. 3. The system may employ ensemble methods to combine the outputs of these different algorithms, potentially leveraging the strengths of each to create more robust and accurate predictions. This multi-algorithm technique may be particularly useful when generating the monthly prediction models 314 illustrated in FIG. 3, as different algorithms may capture different temporal patterns or seasonal effects. The diverse capabilities of these algorithms may also contribute to more nuanced subscriber segmentation, as shown in the ventile distribution of FIG. 4, potentially enabling more targeted and effective marketing strategies.

CatBoost, a gradient boosting algorithm, may in some examples be particularly well-suited for subscriber reactivation prediction due to its unique features and capabilities. The algorithm may process the historical data 218 shown in FIG. 2, which may include a wide range of information such as viewing habits, subscription history, and demographic details. CatBoost may excel at identifying complex, non-linear relationships within this data, potentially uncovering subtle patterns that may influence a subscriber's likelihood of reactivation. Unlike some other algorithms, CatBoost may automatically handle categorical features without the need for extensive preprocessing, which may be advantageous when dealing with diverse subscriber data. This capability may be especially useful when processing the various data types represented in the historical data 304 of FIG. 3, such as viewership patterns, subscription packages, and activation history. The algorithm's ordered boosting technique may help mitigate target leakage, a common issue in time-dependent prediction tasks, which may be particularly relevant when generating the monthly prediction models 314 shown in FIG. 3. Furthermore, CatBoost's symmetric tree structure may allow for faster inference times, which may be beneficial when applying the models in real-time to generate the subscriber restart probabilities 224 depicted in FIG. 2. When segmenting subscribers into ventiles as illustrated in FIG. 4, CatBoost's ability to handle high-cardinality categorical features may prove valuable, potentially allowing for more nuanced segmentation based on a wide array of subscriber characteristics. The algorithm's feature importance calculations may also provide insights into which factors most strongly influence reactivation probabilities, potentially informing the tailored marketing strategies represented by the smartphone screens 404, 406, and 408 in FIG. 4. CatBoost may also incorporate built-in mechanisms for handling missing data, which may be particularly useful when dealing with incomplete subscriber records or sporadic viewing data. Its ability to work effectively with imbalanced datasets may be advantageous in the context of subscriber reactivation, where the number of reactivations may be significantly smaller than the number of non-reactivations. This may lead to more accurate predictions across all probability segments, potentially improving the overall effectiveness of the reactivation campaigns. Additionally, CatBoost's support for GPU acceleration may enable faster model training and updating, which may be beneficial when implementing the automated update process 506 shown in FIG. 5. This may allow for more frequent model refinements, potentially leading to more up-to-date and accurate predictions over time.

In some examples, the system may utilize various types of automated marketing platforms to deliver personalized reactivation messages to former subscribers. These platforms may include email systems, messaging systems, and/or in-app notification systems, each offering unique advantages and capabilities for reaching out to potential reactivators. Email systems may provide a versatile and widely accessible medium for delivering detailed reactivation offers and content recommendations. These systems may support rich HTML formatting, allowing for visually appealing layouts that incorporate branding elements, images of recommended content, and interactive elements such as buttons linking directly to the reactivation process. Email platforms may also offer advanced segmentation and personalization features, potentially enabling the system to tailor the content, subject lines, and sending times based on individual subscriber preferences and behaviors. Messaging systems, on the other hand, may offer a more immediate and direct communication channel. These may include SMS text messaging or messaging apps, which may be particularly effective for delivering concise, time-sensitive offers or reminders. The brevity and high open rates associated with messaging may make this platform well-suited for triggering quick actions, such as prompting a subscriber to reactivate their account before a major sporting event or season premiere. In-app notification systems may provide a seamless and contextually relevant way to reach former subscribers who may still have the service's app installed on their devices. These notifications may appear as pop-ups or banners within the app interface, potentially catching the user's attention while they are already engaging with content-related activities. In-app notifications may be particularly effective for showcasing personalized content recommendations or limited-time offers, as they can provide a frictionless path from the notification directly to the reactivation process within the app. The system may dynamically select the most appropriate platform or combination of platforms for each former subscriber based on factors such as their past engagement patterns, device usage, and predicted reactivation probability. For instance, high-probability reactivators may receive subtle in-app notifications, while medium-probability subscribers might be targeted with a combination of email and messaging to provide more comprehensive information about new features or content. The automated nature of these platforms may allow for precise timing of message delivery, potentially aligning with predicted optimal reactivation periods for each subscriber. Furthermore, these platforms may offer robust analytics and tracking capabilities, enabling the system to monitor open rates, click-through rates, and conversion rates across different message types and subscriber segments. This data may then be fed back into the prediction models, potentially improving the accuracy of future reactivation probability estimates and the effectiveness of subsequent marketing campaigns.

In some examples, the system may employ sophisticated techniques for storing prediction models in specialized data structures and implementing dynamic retraining processes based on actual reactivation outcomes. The storage of prediction models may utilize a highly optimized data structure that efficiently maps each subset of the overall time period to its corresponding prediction model. This mapping technique may involve the use of a hash table or a balanced tree structure, potentially allowing for rapid retrieval of the appropriate model when a specific time period is queried. The data structure may be designed to accommodate multiple versions of each model, enabling the system to maintain historical snapshots alongside the most current iterations. This versioning capability may prove valuable for analyzing model evolution over time and potentially rolling back to previous versions if needed. The storage system may also implement compression algorithms tailored to the specific characteristics of machine learning models, potentially reducing memory footprint without sacrificing quick access times. In terms of model selection, the system may employ a sophisticated lookup mechanism that considers not only the target time period but also additional contextual factors such as market conditions or subscriber segments, potentially allowing for more nuanced model application.

The retraining process based on actual reactivations may involve a continuous feedback loop that compares predicted probabilities with observed outcomes. This evaluation may occur over predetermined periods, which may be dynamically adjusted based on the volume of reactivation data and the observed rate of model drift. The system may employ various metrics to quantify prediction accuracy, such as AUC score, precision, recall, and lift charts, providing a comprehensive assessment of model performance across different probability thresholds. When discrepancies between predictions and actual reactivations are detected, the system may trigger an automated retraining pipeline. This pipeline may incorporate incremental learning techniques, allowing the models to adapt to new patterns without requiring a full retrain on the entire historical dataset. The retraining process may also involve feature importance analysis, potentially identifying which factors have become more or less predictive of reactivation over time. This insight may inform dynamic feature selection, where the set of input variables used by the models is periodically updated to maintain optimal predictive power.

Furthermore, the retraining mechanism may implement concept drift detection algorithms to identify when the underlying patterns in the data have significantly shifted, potentially necessitating more substantial model adjustments or even architectural changes. The system may also employ ensemble techniques during retraining, potentially combining newly trained models with existing ones to create more robust and stable predictions. To ensure the reliability of the retraining process, the system may implement safeguards such as performance regression testing, where updated models are validated against holdout datasets before being deployed into production. Additionally, the retraining pipeline may be designed with fault tolerance in mind, potentially utilizing distributed computing resources to ensure uninterrupted model updating even in the face of hardware failures or data processing anomalies. By continuously refining the models based on actual reactivation data, the system may adapt to changing subscriber behaviors, market conditions, and content offerings, potentially maintaining or improving its predictive accuracy over time.

In some examples, the system may implement a highly automated monthly process for running the prediction models and generating subscriber reactivation probabilities. This process may be orchestrated by a sophisticated scheduling system that may trigger the model execution pipeline at predetermined intervals, typically aligned with the start of each calendar month. The automation may begin with a data ingestion phase, where the system may collect and preprocess the latest subscriber information, including recent viewing patterns, account status changes, and any relevant external data such as market trends or competitive offerings. This data may be automatically validated and cleaned to ensure consistency and quality before being fed into the prediction models. The system may then sequentially apply each of the monthly-specific models to the current dataset, potentially utilizing distributed computing resources to parallelize the process and reduce overall execution time. As the models generate predictions, the results may be automatically aggregated and post-processed, potentially applying calibration techniques to ensure consistency across different time periods. The system may also implement automated quality checks at various stages of the process, potentially flagging anomalies or unexpected shifts in prediction patterns for human review. Once the predictions are finalized, the automation may extend to the segmentation of subscribers into ventiles or other predefined groups based on their reactivation probabilities. This segmentation may then trigger automated marketing workflows, potentially generating personalized reactivation messages and scheduling their delivery through various channels. The monthly cadence may allow for a balance between timely predictions and computational efficiency, providing regular updates to account for evolving subscriber behaviors while avoiding excessive processing overhead. Additionally, the automated process may include a feedback loop where the actual reactivation outcomes from the previous month are automatically compared to the predictions, potentially calculating performance metrics and storing this information for future model refinement. The system may also generate comprehensive reports summarizing the month's predictions, segmentation results, and initial marketing campaign performance, which may be automatically distributed to relevant stakeholders. To ensure reliability, the automated process may incorporate fault-tolerant mechanisms, such as automatic retries for failed components and redundant processing paths, potentially minimizing the risk of disruptions to the monthly cycle. Furthermore, the system may maintain detailed logs of each step in the automated process, potentially facilitating troubleshooting and auditing. This high level of automation may enable the consistent and timely application of the prediction models, potentially allowing marketing teams to focus on strategy and creative aspects while the system handles the complex computational tasks on a regular monthly basis.

In some examples, the system may employ advanced data preprocessing and feature engineering techniques to help improve or enhance the input data for the prediction models. The preprocessing phase may begin with comprehensive data cleansing procedures, which may include identifying and handling missing values through techniques such as mean imputation, median imputation, and/or more sophisticated methods like k-nearest neighbor imputation. Outlier detection algorithms may be applied to identify and potentially adjust extreme values that could skew the model's performance. The system may also implement data normalization and/or standardization techniques to ensure that all features are on comparable scales, which may improve the convergence of certain machine learning algorithms. Feature engineering may play a significant role in enhancing the predictive power of the models. This process may involve creating derived features that capture complex relationships within the data. For instance, the system may generate interaction terms between existing features, such as combining viewing duration with content genre to create a more nuanced engagement metric. Time-based features may be extracted from timestamp data, potentially capturing seasonal patterns and/or day-of-week effects in viewing behavior. The system may also employ dimensionality reduction techniques like Principal Component Analysis (PCA) and/or t-SNE to identify latent factors that may influence subscriber reactivation probabilities. Text data from subscriber feedback and/or content descriptions may be processed using natural language processing techniques, potentially extracting sentiment scores and/or topic classifications that may serve as additional predictive features. The feature engineering process may also involve the creation of lag features and/or rolling statistics to capture temporal trends in subscriber behavior. Additionally, the system may implement automated feature selection algorithms, such as recursive feature elimination and/or Lasso regularization, to identify the most relevant predictors for each model. These algorithms may be run periodically to adapt the feature set as new data becomes available and/or market conditions change. The system may also employ domain-specific feature engineering, leveraging expert knowledge to create custom metrics that may be particularly indicative of reactivation likelihood in the context of streaming services and/or other subscription-based platforms. Furthermore, the preprocessing and feature engineering pipeline may be designed with scalability in mind, potentially utilizing distributed computing frameworks to handle large volumes of data efficiently. The system may also implement versioning for the preprocessed datasets and engineered features, allowing for easy rollback and/or A/B testing of different feature sets. By applying these sophisticated preprocessing and feature engineering techniques, the system may significantly enhance the quality and relevance of the input data, potentially leading to more accurate and robust prediction models for subscriber reactivation probabilities.

In some examples, the system may implement a sophisticated cross-platform data integration technique to create comprehensive user profiles that incorporate interactions from both TV and mobile app platforms. This integration process may begin with the establishment of a unified data architecture that allows for seamless aggregation of diverse data streams. The system may utilize a distributed data processing framework, such as Apache Hadoop and/or Apache Spark, to efficiently handle the large volumes of data generated across platforms. To ensure accurate data fusion, the system may employ advanced identity resolution algorithms that may link user activities across different devices and platforms to a single user profile. This may involve techniques such as probabilistic matching based on IP addresses, device fingerprinting, and/or login credentials. Once the data streams are consolidated, the system may apply sophisticated data harmonization techniques to standardize formats and metrics across platforms. For instance, viewing duration on TV may be normalized to be comparable with app engagement time, potentially creating a unified engagement metric. The integrated data may then be enriched with platform-specific context, such as tagging TV viewing sessions with information about the viewing environment (e.g., time of day, day of week, household composition) and augmenting mobile app interactions with device-specific data (e.g., operating system, screen size, connectivity type). The system may also implement advanced session stitching algorithms to reconstruct a user's content consumption journey across platforms, potentially revealing cross-platform viewing patterns and content discovery behaviors. Feature engineering techniques may be applied to the integrated data to create cross-platform metrics, such as the ratio of mobile to TV viewing time and/or the frequency of platform switching within a single content viewing session. The system may utilize natural language processing techniques to analyze user-generated content, such as reviews and/or comments, from both platforms, potentially extracting sentiment and topic information to enrich the user profile. Additionally, the system may employ machine learning algorithms to identify latent patterns in cross-platform behavior that may be indicative of subscription status and/or reactivation likelihood. To handle the temporal aspects of cross-platform data, the system may implement time series analysis techniques, potentially capturing evolving user preferences and engagement patterns across devices. The integrated user profiles may be continuously updated in real-time as new data becomes available, with the system potentially utilizing stream processing technologies to handle high-velocity data ingestion. To address privacy concerns, the system may implement robust data anonymization and encryption protocols, ensuring that personally identifiable information is protected throughout the integration process. The resulting comprehensive user profiles may provide a holistic view of subscriber behavior, potentially enabling more accurate prediction of reactivation probabilities and more personalized content recommendations and/or marketing strategies. These profiles may be made available through a unified API, allowing various components of the prediction and marketing systems to access a consistent and comprehensive set of user data. By leveraging this sophisticated cross-platform data integration technique, the system may gain deeper insights into user behavior and preferences, potentially enhancing the accuracy and effectiveness of its subscriber reactivation predictions and strategies.

In some examples, the system may employ a sophisticated A/B testing framework integrated with continuous refinement processes to optimize marketing messages and strategies for subscriber reactivation. This framework may utilize advanced experimental design techniques to create statistically rigorous tests across various aspects of the marketing campaigns. The system may automatically generate multiple variants of reactivation messages, potentially differing in content, tone, visual elements, and/or offer structures. These variants may be systematically assigned to different segments of the target audience, with the assignment process potentially leveraging randomization algorithms to ensure unbiased sample distribution. The A/B testing framework may incorporate multi-armed bandit algorithms, which may dynamically adjust the allocation of users to different variants based on real-time performance data, potentially maximizing the overall effectiveness of the campaign while continuing to explore new options. The system may track a wide range of metrics for each variant, including open rates, click-through rates, conversion rates, and time-to-conversion, potentially utilizing advanced analytics tools to process and visualize this data in real-time. Statistical significance calculations may be automatically performed as data accumulates, with the system potentially triggering alerts when a variant shows a significant improvement or decline in performance. The A/B testing process may extend beyond simple message content to encompass more complex elements such as the timing of message delivery, the sequence of multiple messages in a reactivation campaign, and/or the interaction between message content and subscriber segmentation. The system may implement factorial design techniques to efficiently test combinations of these elements, potentially uncovering interaction effects that may not be apparent from simpler A/B tests. Machine learning algorithms may be employed to analyze the results of multiple A/B tests over time, potentially identifying patterns in successful marketing strategies across different subscriber segments and/or time periods. This analysis may feed into a continuous refinement process, where insights from A/B tests are automatically incorporated into the generation of new marketing message variants and/or the adjustment of targeting strategies. The system may also implement contextual bandit algorithms, which may take into account subscriber attributes and/or environmental factors when deciding which variant to show, potentially allowing for more personalized optimization. To handle the complexity of multi-variant testing, the system may utilize Bayesian optimization techniques, which may efficiently explore the high-dimensional space of possible marketing strategies while balancing exploration and exploitation. The A/B testing framework may be integrated with the automated marketing platforms, potentially allowing for seamless deployment of test variants across email, messaging, and/or in-app notification channels. Furthermore, the system may implement safeguards to prevent test fatigue among subscribers, potentially limiting the frequency with which an individual is included in A/B tests and/or ensuring that the overall subscriber experience remains consistent despite ongoing experimentation. The results of A/B tests may also be used to refine the prediction models themselves, potentially improving their ability to identify subscribers who are most likely to respond positively to specific types of reactivation messages. By leveraging this comprehensive A/B testing and continuous refinement technique, the system may systematically improve the effectiveness of its marketing strategies over time, potentially leading to higher reactivation rates and more efficient use of marketing resources.

In some examples, the system may employ advanced techniques for handling imbalanced datasets, where reactivations may be significantly less common than non-reactivations among former subscribers. This imbalance may pose challenges for machine learning algorithms, potentially leading to biased models that underpredict the minority class of reactivations. To address this issue, the system may implement a multi-faceted technique that combines data-level and algorithm-level solutions. At the data level, the system may utilize oversampling methods such as Synthetic Minority Over-sampling Technique (SMOTE) and/or its variants like Borderline-SMOTE and/or Adaptive Synthetic (ADASYN). These techniques may generate synthetic examples of the minority class by interpolating between existing reactivation instances, potentially creating a more balanced dataset for model training. Simultaneously, the system may apply undersampling techniques to the majority class, such as Random Under-Sampling and/or Tomek links removal, to reduce the dominance of non-reactivation examples. The system may also implement hybrid methods that combine both oversampling and undersampling, such as SMOTEENN and/or SMOTETomek, to achieve an optimal balance. To prevent overfitting when applying these sampling techniques, the system may employ stratified k-fold cross-validation, ensuring that the class distribution is maintained across training and validation sets. At the algorithm level, the system may utilize cost-sensitive learning techniques, assigning higher misclassification costs to the minority class during model training. This may be achieved through weighted loss functions in algorithms like gradient boosting and/or by adjusting class weights in support vector machines. For ensemble methods, the system may implement techniques such as Balanced Random Forest and/or EasyEnsemble, which may create balanced subsets of the data for training individual models within the ensemble. The system may also explore anomaly detection algorithms, treating reactivations as rare events and leveraging techniques like Isolation Forest and/or One-Class SVM to identify potential reactivators. To evaluate model performance on imbalanced data, the system may utilize metrics that are less sensitive to class imbalance, such as the Area Under the Precision-Recall Curve (AUPRC), F1-score, and/or Matthews Correlation Coefficient (MCC). These metrics may provide a more nuanced view of model performance compared to accuracy alone. The system may also implement threshold-moving techniques, adjusting the decision threshold of classifiers to optimize for specific performance metrics or business objectives. Furthermore, the system may employ advanced ensemble techniques specifically designed for imbalanced learning, such as RUSBoost and/or SMOTEBoost, which may combine data sampling with boosting algorithms to improve performance on the minority class. To address temporal aspects of imbalance, where reactivation patterns may change over time, the system may implement adaptive learning techniques that continuously adjust the sampling and/or algorithmic parameters based on the current data distribution. The system may also explore transfer learning techniques, leveraging knowledge from related tasks or domains where data may be more balanced to improve performance on the imbalanced reactivation prediction task. By employing this comprehensive technique for handling imbalanced datasets, the system may generate more accurate and reliable predictions of subscriber reactivations, potentially leading to more effective targeting of marketing efforts and improved overall campaign performance.

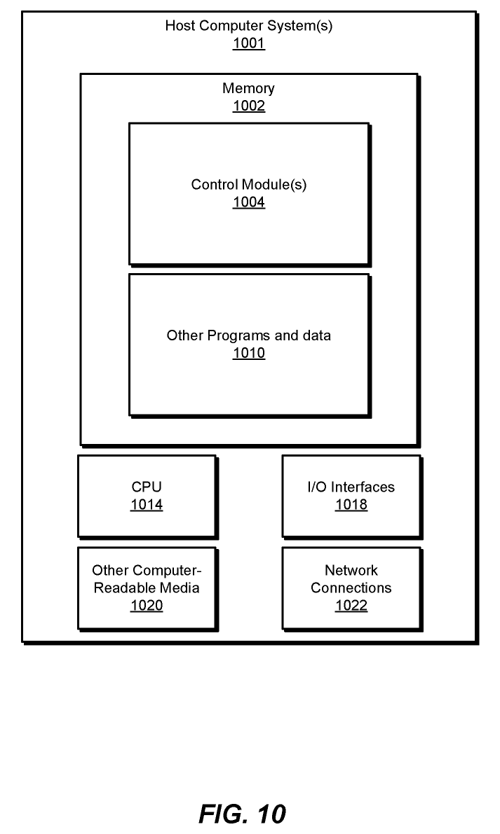

FIG. 10 shows a system diagram that describes an example implementation of a computing system(s) for implementing embodiments described herein. The functionality described herein may be implemented either on dedicated hardware, as a software instance running on dedicated hardware, or as a virtualized function instantiated on an appropriate platform, e.g., a cloud infrastructure. In some embodiments, such functionality may be completely software-based and designed as cloud-native, meaning that they are agnostic to the underlying cloud infrastructure, enabling higher deployment agility and flexibility. However, FIG. 10 illustrates an example of underlying hardware on which such software and functionality may be hosted and/or implemented.

In particular, shown is example host computer system(s) 1001. For example, such computer system(s) 1001 may execute a scripting application, or other software application, as further discussed above, and/or to perform one or more of the other methods described herein. In some embodiments, one or more special-purpose computing systems may be used to implement the functionality described herein. Accordingly, various embodiments described herein may be implemented in software, hardware, firmware, or in some combination thereof. Host computer system(s) 1001 may include memory 1002, one or more central processing units (CPUs) 1014, I/O interfaces 1018, other computer-readable media 1020, and network connections 1022.

Memory 1002 may include one or more various types of non-volatile and/or volatile storage technologies. Examples of memory 1002 may include, but are not limited to, flash memory, hard disk drives, optical drives, solid-state drives, various types of random access memory (RAM), various types of read-only memory (ROM), neural networks, other computer-readable storage media (also referred to as processor-readable storage media), or the like, or any combination thereof. Memory 1002 may be utilized to store information, including computer-readable instructions that are utilized by CPU 1014 to perform actions, including those of embodiments described herein.

Memory 1002 may have stored thereon control module(s) 1004. The control module(s) 1004 may be configured to implement and/or perform some or all of the functions of the systems or components described herein. Memory 1002 may also store other programs and data 1010, which may include rules, databases, application programming interfaces (APIs), software containers, nodes, pods, clusters, node groups, control planes, software defined data centers (SDDCs), microservices, virtualized environments, software platforms, cloud computing service software, network management software, network orchestrator software, network functions (NF), artificial intelligence (AI) or machine learning (ML) programs or models to perform the functionality described herein, user interfaces, operating systems, other network management functions, other NFs, etc.

Network connections 1022 are configured to communicate with other computing devices to facilitate the functionality described herein. In various embodiments, the network connections 1022 include transmitters and receivers (not illustrated), cellular telecommunication network equipment and interfaces, and/or other computer network equipment and interfaces to send and receive data as described herein, such as to send and receive instructions, commands and data to implement the processes described herein. I/O interfaces 1018 may include a video interface, other data input or output interfaces, or the like. Other computer-readable media 1020 may include other types of stationary or removable computer-readable media, such as removable flash drives, external hard drives, or the like.

The various embodiments described above may be combined to provide further embodiments. These and other changes may be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

Claims:

1. A method comprising:
generating, using a machine learning algorithm, prediction models where each of the prediction models corresponds to a respective subset of an overall time period such that each of the prediction models predicts, for each former subscriber in an input set of former subscribers, a probability of the former subscriber restarting a subscription during the subset of the overall time period;
applying, based on a determination that an actual subset of the overall time period is arriving, a specific prediction model for that actual subset of the overall time period such that a target set of former subscribers is identified that identifies former subscribers with a probability of restarting their subscription beyond a predetermined threshold during the actual subset of the overall time period; and
transmitting, via an automated marketing platform during or prior to the actual subset of the overall time period, respective reactivation messages to the target set of former subscribers based on the former subscribers in the target set of former subscribers having the probability of restarting their subscription beyond the predetermined threshold during the actual subset of the overall time period according to the machine learning algorithm.

2. The method of claim 1, wherein the machine learning algorithm comprises a tree-based decision algorithm.

3. The method of claim 2, wherein the tree-based decision algorithm comprises a gradient boosting algorithm.

4. The method of claim 1, wherein the machine learning algorithm comprises a Naive Bayes algorithm.

5. The method of claim 1, further comprising automatically updating the prediction models on a recurring basis using newly acquired subscriber data.

6. The method of claim 1, wherein each subset of the overall time period corresponds to a month.

7. The method of claim 1, further comprising segmenting former subscribers into ventiles based on their predicted probabilities of restarting their subscription.

8. The method of claim 1, wherein generating the prediction models comprises using historical data of former subscribers, the historical data comprising viewership patterns, subscription packages, or activation history.

9. The method of claim 1, wherein the reactivation messages comprise personalized content based on their predicted probability.

10. The method of claim 1, further comprising suppressing marketing efforts for a subset of former subscribers based on their predicted probability of restarting their subscription failing to satisfy the predetermined threshold.

11. The method of claim 1, further comprising determining an offer for each former subscriber in the target set of former subscribers based on their predicted probability of restarting their subscription.

12. The method of claim 1, wherein the automated marketing platform comprises an email system, a messaging system, or an in-app notification system.

13. The method of claim 1, further comprising:
predicting content preferences for each former subscriber in the target set of former subscribers based on their historical viewership data; and
including content recommendations in the reactivation messages based on the predicted content preferences.

14. The method of claim 1, further comprising adjusting the predetermined threshold based on market conditions.

15. The method of claim 1, further comprising:
storing the prediction models in a data structure that maps each subset of the overall time period to its corresponding prediction model; and
selecting, based on the actual subset of the overall time period, the corresponding prediction model from the data structure for applying.

16. The method of claim 1, further comprising:
tracking, over a predetermined evaluation period, actual reactivations of the former subscribers;
comparing the actual reactivations to the probabilities predicted by the prediction models; and
retraining the prediction models based on results of the comparing to improve prediction accuracy.

17. A non-transitory computer-readable medium that has instructions stored thereon that, when executed by at least one physical computing processor, cause a computing device to perform operations comprising:
generating, using a machine learning algorithm, prediction models where each of the prediction models corresponds to a respective subset of an overall time period such that each of the prediction models predicts, for each former subscriber in an input set of former subscribers, a probability of the former subscriber restarting a subscription during the subset of the overall time period;
applying, based on a determination that an actual subset of the overall time period is arriving, a specific prediction model for that actual subset of the overall time period such that a target set of former subscribers is identified that identifies former subscribers with a probability of restarting their subscription beyond a predetermined threshold during the actual subset of the overall time period; and
transmitting, via an automated marketing platform during or prior to the actual subset of the overall time period, respective reactivation messages to the target set of former subscribers based on the former subscribers in the target set of former subscribers having the probability of restarting their subscription beyond the predetermined threshold during the actual subset of the overall time period according to the machine learning algorithm.

18. The non-transitory computer-readable medium of claim 17, wherein the machine learning algorithm comprises a tree-based decision algorithm.

19. A system comprising:
at least one physical computing processor of a computing device; and
a non-transitory computer-readable medium that has instructions stored thereon that, when executed by the at least one physical computing processor, cause the computing device to perform operations comprising:
generating, using a machine learning algorithm, prediction models where each of the prediction models corresponds to a respective subset of an overall time period such that each of the prediction models predicts, for each former subscriber in an input set of former subscribers, a probability of the former subscriber restarting a subscription during the subset of the overall time period;
applying, based on a determination that an actual subset of the overall time period is arriving, a specific prediction model for that actual subset of the overall time period such that a target set of former subscribers is identified that identifies former subscribers with a probability of restarting their subscription beyond a predetermined threshold during the actual subset of the overall time period; and
transmitting, via an automated marketing platform during or prior to the actual subset of the overall time period, respective reactivation messages to the target set of former subscribers based on the former subscribers in the target set of former subscribers having the probability of restarting their subscription beyond the predetermined threshold during the actual subset of the overall time period according to the machine learning algorithm.

20. The system of claim 19, wherein the machine learning algorithm comprises a tree-based decision algorithm.
